(19) United States
(12) Patent Application Publication
(10) Pub. No.: US 2015/0326677 A1
(43) Pub. Date: Nov. 12, 2015

(54) SCREEN INFORMATION COLLECTING COMPUTER, SCREEN INFORMATION COLLECTING METHOD, AND COMPUTER-READABLE STORAGE MEDIUM

(71) Applicant: Takayuki MURAOKA, Tokyo (JP)

(72) Inventor: Takayuki MURAOKA, Tokyo (JP)

(73) Assignee: Hitachi Ltd.

(21) Appl. No.: 14/396,288

(22) PCT Filed: Jun. 18, 2012
(86) PCT No.: PCT/JP2012/065465

§ 371 Date: Oct. 22, 2014

(51) Int. Cl. H04L 29/08; H04L 29/06; G06F 17/30

(52) U.S. Cl. CPC H04L 67/22; G06F 17/3051; G06F 17/30876; H04L 67/42

(57) ABSTRACT

It is provided a screen information collecting computer for collecting client screen information serving as information on a client screen from a client computer for receiving a user's operation on the client screen being displayed, the screen information collecting computer comprising: a client screen information collection part for collecting the client screen information from the client computer; an operation information collection part for collecting operation information indicating information by which the user's operation performed on the client screen is identifiable; and a trigger operation determination part for determining, among the user's operations on the client screen, a trigger operation indicating a timing to control the client screen information collection part to collect the client screen information, the trigger operation determination part being configured to determine the trigger operation based on the client screen information displayed on the client computer and the operation information.

### BACKGROUND OF THE INVENTION

This invention relates to a screen information collecting computer and the like for collecting client screen information from a client computer.

It is general that various services relating to social infrastructures and mission-critical tasks of companies are provided as Web applications on the Internet and intranets, and it is demanded that the cause of a system trouble of a Web application be identified quickly and such a system trouble be handled quickly. On the other hand, a mechanism for realizing a Web application is further improving and becoming more complicated day by day, and a degree of difficulty in identifying the cause of a system trouble tends to become higher. In addition, it is predicted that a recent rise of the mobile device environment such as a smartphone further increases the degree of difficulty in identifying the cause of a system trouble.

In a Web application, screen information to be displayed on a client is generated on a server, while the server transmits the generated screen information to the client. Therefore, a screen displayed by the client immediately after the server transmits the screen information is held by the server, which allows an administrator of the server to easily confirm this screen. The screen displayed by the client changes depending on a user's operation received by the client.

In a behavior analysis of an application for identifying the cause of a system trouble, screen information on which the user's operation received by the client has been reflected may be often necessary. The server can acquire the screen information displayed on the client by embedding processing for acquiring the screen information into a screen script generated for displaying the screen information on the client. However, a data amount of the screen information is generally large, and there is a limitation on a storage capacity of the server in terms of size, which makes it necessary for the server to acquire the screen information displayed on the client at an appropriate timing.

As a technology for acquiring the screen information, there is JP 2011-76152 A. In JP 2011-76152A, there is a description (refer to Abstract) that “A capture system for capturing the display content of an item required to be visually checked on screen in a screen provided to a Web browser by a Web application includes an analyzing means for analyzing a check list where an item required to be checked on screen and the check content are defined for every test case; a capture acquiring means for capturing and storing in an image file only a specific item defined on the check list, in accordance with the result of analysis by the analyzing means, in the screen provided by the Web application; a capture acquisition result generating means for associating an acquired image file and the check content and generating a check screen file; and a capture acquisition result displaying means for displaying the content of the check screen file generated by the capture acquisition result generating means.”

### SUMMARY OF THE INVENTION

However, the screen information acquisition timing for the server depends on implementation of each Web application and a state transition of a system that runs the Web application, and hence technical knowledge and know-how regarding the Web application are required for the administrator to determine the screen information acquisition timing.

In addition, the screen information acquisition timing also depends on how the Web application is used, which makes it difficult for the administrator to determine the screen information acquisition timing while developing the Web application.

JP 2011-76152 A discloses only the capturing of the specific items defined in the checklist, but does not disclose an acquisition timing for image information, thereby failing to solve the above-mentioned problem.

The present invention is carried out in consideration of these problems, and an object of the present invention is to provide a computer for automatically determining an optimal acquisition timing for screen information displayed in a client.

The representative one of inventions disclosed in this application is outlined as follows. There is provided a screen information collecting computer for collecting client screen information serving as information on a client screen from a client computer for receiving a user's operation on the client screen being displayed, the screen information collecting computer comprising: a client screen information collection part for collecting the client screen information from the client computer; an operation information collection part for collecting operation information indicating information by which the user's operation performed on the client screen is identifiable; and a trigger operation determination part for determining, among the user's operations on the client screen, a trigger operation indicating a timing to control the client screen information collection part to collect the client screen information, the trigger operation determination part being configured to determine the trigger operation based on the client screen information displayed on the client computer and the operation information.

According to the exemplary embodiment of this invention, it is possible to provide a computer for automatically determining an optimal acquisition timing for screen information displayed in a client.

### BRIEF DESCRIPTION OF THE DRAWINGS

FIG. 1 is an explanatory diagram of the outline of an embodiment of this invention.

FIG. 2 is a first sequence diagram illustrating an outline of the embodiment of this invention.

FIG. 3 is a second sequence diagram illustrating an outline of the embodiment of this invention.

FIG. 4 is a functional block diagram of a client PC according to the embodiment of this invention.

FIG. 5 is a functional block diagram of a server according to the embodiment of this invention.

FIG. 6 is a flowchart of entire processing performed in an information processing system according to the embodiment of this invention.

FIG. 7 is an explanatory diagram of a screen script table according to the embodiment of this invention.

FIG. 8 is an explanatory diagram of an operation history table according to the embodiment of this invention.

FIG. 9 is an explanatory diagram of an log table according to the embodiment of this invention.

FIG. 10 is an explanatory diagram of a trigger operation identifying information table according to the embodiment of this invention.

FIG. 11 is an explanatory diagram of a trigger extraction policy table according to the embodiment of this invention.

FIG. 12 is an explanatory diagram of trigger extraction processing executed when the server according to the embodiment of this invention generates a specific screen script.

FIG. 13 is an explanatory diagram of trigger extraction processing executed when the client PC according to the embodiment of this invention receives trigger extraction operation on a specific screen.

FIG. 14 is an explanatory diagram of the trigger extraction processing executed when the server according to the embodiment of this invention outputs a specific log.

FIG. 15 is a specific explanatory diagram of the trigger extraction processing executed when the server according to the embodiment of this invention generates the specific screen script.

FIG. 16 is a specific explanatory diagram of trigger acquisition processing according to the embodiment of this invention.

FIG. 17 is an explanatory diagram of a specific example of the trigger extraction processing executed when the client PC according to the embodiment of this invention receives the trigger extraction operation on the specific screen.

FIG. 18 is an explanatory diagram of a specific example of the trigger extraction processing executed when the server according to the embodiment of this invention outputs the specific log.

FIG. 19 is an explanatory diagram of the outline of the trigger extraction scheme “a” according to the embodiment of this invention.

FIG. 20 is an explanatory diagram of the outline of the trigger extraction scheme “b” according to the embodiment of this invention.

FIG. 21 is an explanatory diagram of a trigger extraction policy setting screen according to the embodiment of this invention.

FIG. 22 is an explanatory diagram of the trigger extraction policy setting screen according to the embodiment of this invention.

FIG. 23 is a flowchart of the entire trigger extraction processing according to the embodiment of this invention.

FIG. 24 is a flowchart of the trigger extraction processing based on the trigger extraction scheme “a” according to the embodiment of this invention.

FIG. 25 is a flowchart of the trigger extraction processing based on the trigger extraction scheme “b” according to the embodiment of this invention.

FIG. 26 is an explanatory diagram of a trigger operation display screen according to the embodiment of this invention.

FIG. 27 is an explanatory diagram of a client screen information display screen according to the embodiment of this invention.

### DETAILED DESCRIPTION OF THE PREFERRED EMBODIMENTS

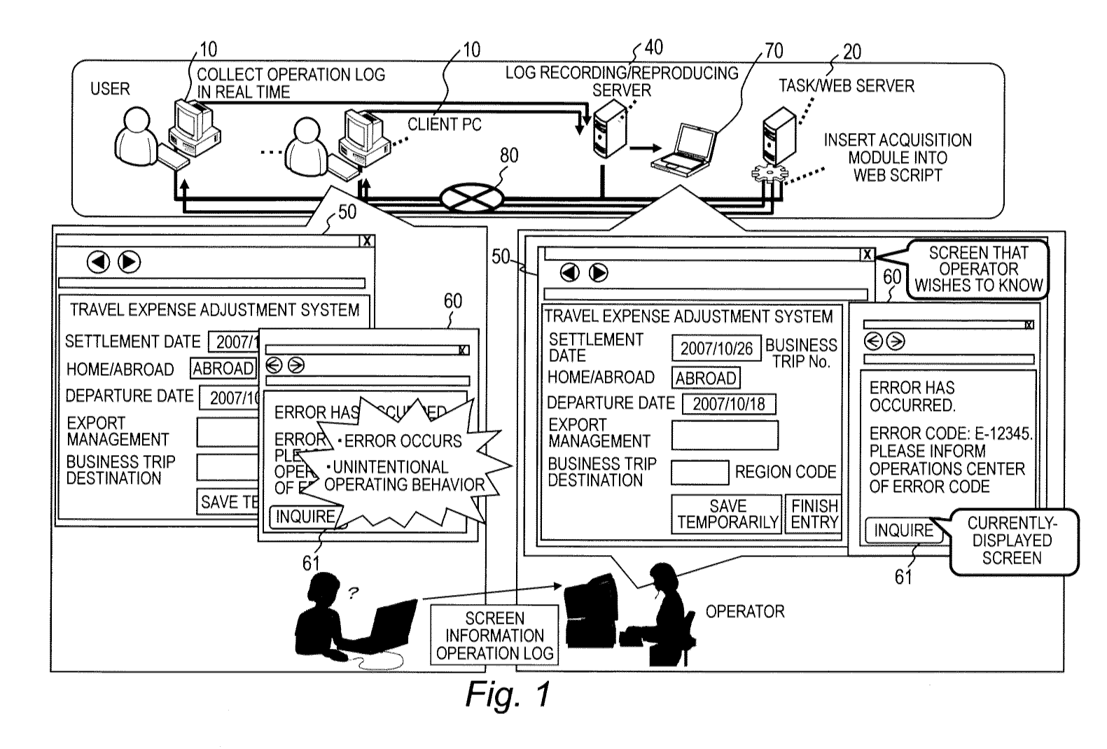

An embodiment of this invention is described with reference to FIG. 1 to FIG. 27.

First, an outline of this embodiment is described with reference to FIG. 1 to FIG. 3.

FIG. 1 is an explanatory diagram of the outline of the embodiment of this invention.

An information processing system according to this embodiment includes a client computer (PC) 10, a task/Web server 20, and a log recording/reproducing server 40. The client PC 10, the task/Web server 20, and the log recording/reproducing server 40 are coupled to one another through a network 80.

The client PC 10 executes a screen script transmitted from the task/Web server 20, displays a client screen, and receives an input from a user through the displayed client screen. When a predetermined button is operated on the client screen, the client PC 10 transmits a request to the task/Web server 20. Further, the client PC 10 transmits client screen information and operation information indicating details of an operation performed on the client screen to the log recording/reproducing server 40.

The task/Web server 20 receives the request transmitted by the client PC 10, executes processing corresponding to the request, generates a screen script for displaying the client screen corresponding to an execution result on the client PC 10, and transmits the generated screen script to the client PC 10.

The log recording/reproducing server 40 records the client screen information and the operation information that are transmitted from the client PC 10, and displays the client screen information and the operation information that are recorded.

In FIG. 1, the client PC 10 executes the task application for a travel expense adjustment system, and displays a travel expense adjustment system screen 50 as the client screen. A user operates the client screen of the travel expense adjustment system to input information to each of input items (such as adjustment date, home/abroad, departure date, export management, and business trip destination) of the travel expense adjustment system screen 50, and the client PC 10 receives the input operation from the user. When an error occurs during the input operation, the client PC 10 displays an error screen 60 including an inquiry button 61 as the client screen.

When receiving the user's operation for pressing the inquiry button 61 on the error screen 60, the client PC 10 transmits the currently-displayed error screen 60 to the log recording/reproducing server 40 as the client screen information.

When receiving the client screen information on the error screen 60, the log recording/reproducing server 40 records the received information on the error screen 60, and notifies an operator terminal 70 managed by an operator that an error has occurred.

By the operator's operation, the operator terminal 70 displays the error screen 60 currently displayed on the client PC 10 on which the error has occurred and recorded on the log recording/reproducing server 40. Here, the occurrence of the error has been caused by an input operation performed on the travel expense adjustment system screen 50, and hence information that the operator wishes to know exists not on the error screen 60 but on the travel expense adjustment system screen 50. Therefore, the operator needs to ask the user for explanation of details of the user's operation performed on the travel expense adjustment system screen 50, but it is difficult for the user to explain the details of the user's operation.

In this embodiment, based on the client screen information, the operation information, and the like that are recorded, the log recording/reproducing server 40 determines the user's operation (trigger operation) indicating a timing to control the log recording/reproducing server 40 to transmit the client screen information to the client PC 10. Based on the client screen information and the operation information that are recorded, the log recording/reproducing server 40 determines, as a trigger operation, an operation that is highly likely to cause a specific state (for example, error) on the task/Web server 20 and the client PC 10. When the client PC 10 receives the trigger operation, the log recording/reproducing server 40 acquires the client screen displayed on the client PC 10.

For example, in FIG. 1, in a case where the trigger operation is determined as the input operation for the item “departure date” performed on the travel expense adjustment system screen 50, when receiving the input operation for the item “departure date” performed on the travel expense adjustment system screen 50, the client PC 10 transmits information on the travel expense adjustment system screen 50 on which the input operation has been reflected to the log recording/reproducing server 40 as the client screen information. The log recording/reproducing server 40 can acquire the information on the travel expense adjustment system screen 50 on which the input operation for the item “departure date” has been reflected, and therefore can display the client screen that the operator wishes to know on the operator terminal 70. This allows the operator to quickly identify a cause of the error and appropriately support the user.

Further, the log recording/reproducing server 40 records the client screen information obtained when the trigger operation that is highly likely to cause the specific state is received, which can reduce recording capacity used to record the client screen information. Further, the log recording/reproducing server 40 automatically determines the trigger operation based on the client screen information and the operation information, and hence technical knowledge and know-how regarding a Web application are not required for an administrator. In addition, the trigger operation is not set in the log recording/reproducing server 40 in advance, but the log recording/reproducing server 40 determines the trigger operation based on the client screen information and the operation information at a predetermined timing, and hence the trigger operation can be determined in accordance with how the Web application is used.

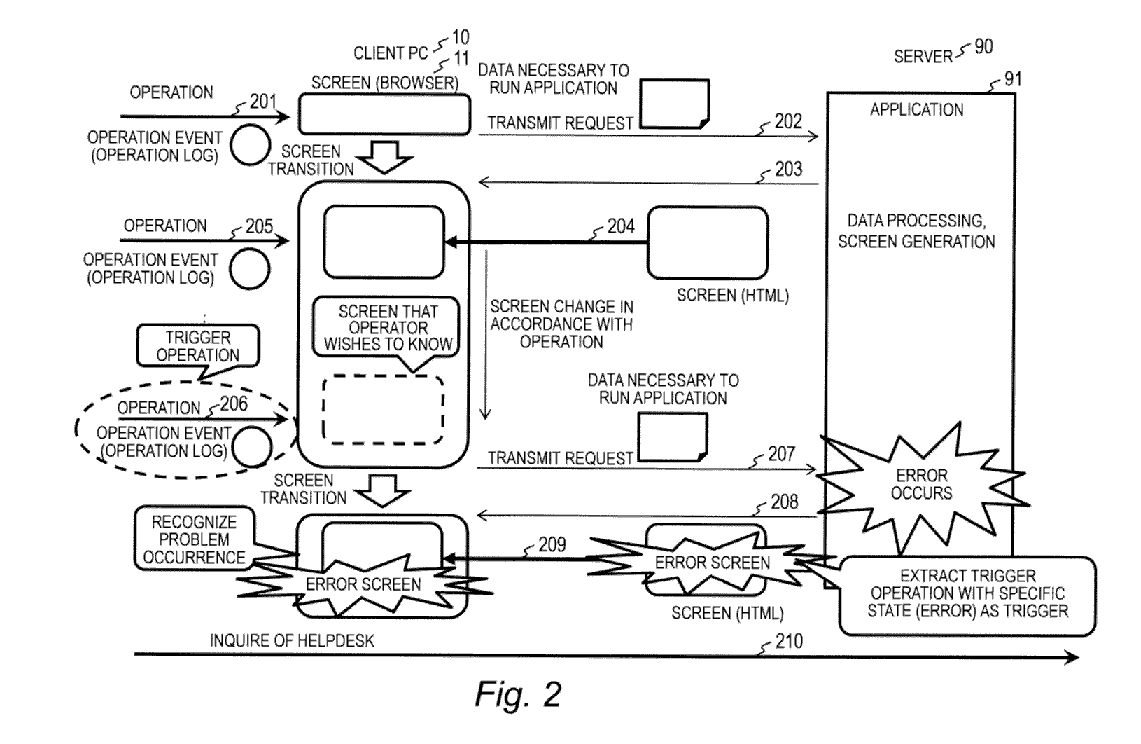

It should be noted that, in FIG. 1, the function of the task/Web server 20 and the function of the log recording/reproducing server 40 may be implemented in one computer, and in the following description, for the sake of simplicity of description, a computer having the function of the task/Web server 20 and the function of the log recording/reproducing server 40 is described as a server 90 as illustrated in, for example, FIG. 2, but this invention is not limited thereto.

FIG. 2 is a first sequence diagram illustrating an outline of the embodiment of this invention.

With reference to FIG. 2, a description is made of a case where an error occurs on the server 90 side when this embodiment is applied to the information processing system.

It is assumed that a browser 11 has been launched on the client PC 10, a predetermined client screen is displayed on the client PC 10, and the server 90 is executing an application 91.

When receiving a predetermined operation from the user through the client screen (201), the client PC 10 transmits the request to the server 90 (202). This request includes data necessary to run the application 91 executed by the server 90 to provide a task. Examples of the predetermined operation by which the client PC 10 transmits a request include an operation performed with respect to a log-in button when the client screen is a login screen. In this case, the client PC 10 transmits a log-in request including a user ID and a password that have been input by the user to the server 90.

When the server 90 receives the request transmitted from the client PC 10 in the processing of Step 201, the application 91 executed by the server 90 transmits an ACK of the received request to the client PC 10 (203). Then, the application 91 executes processing corresponding to the received request, generates a screen script for displaying the client screen corresponding to a processing result on the client PC 10, and transmits the generated screen script to the client PC 10 (204). The screen script generated by the application 91 is described in a language (for example, HTML) that can be interpreted by the browser 11.

When the client PC 10 receives the screen script transmitted from the server 90 in the processing of Step 204, the browser 11 executes the received screen script to display the client screen corresponding to the received screen script. With this configuration, the client screen displayed first on the client PC 10 transitions to the client screen corresponding to the screen script transmitted in the processing of Step 204.

Subsequently, when receiving the user's operation performed on the client screen being displayed (205), the browser 11 stores the received user's operation as the operation log, and changes the client screen based on the received user's operation.

When receiving a predetermined operation performed on the client screen being displayed (206), the browser 11 transmits the request to the server 90 (207).

When the server 90 receives the request transmitted from the client PC 10 in the processing of Step 207, the application 91 transmits an ACK corresponding to the received request to the client PC 10 (208), and executes processing corresponding to the received request. In FIG. 2, it is assumed that an error occurs while this processing is being executed by the application 91.

In this case, the application 91 generates a screen script for displaying an error screen on the client PC 10, and transmits the generated screen script to the client PC 10 (209).

When the client PC 10 receives the screen script transmitted from the server 90 in the processing of Step 209, the browser 11 displays the error screen as the client screen. Then, the user of the client PC 10 recognizes that an error has occurred by viewing the error screen, and inquires of a helpdesk about the error screen (210).

When transmitting the request in the processing of Steps 202 and 207, the client PC 10 transmits only the data necessary to run the application 91, and hence the operation that has caused the error or the client screen information obtained at a time of the operation is not stored on the server 90. Therefore, the server 90 cannot display the screen that an operator of the helpdesk wishes to know.

In this embodiment, for example, in a case where the operation received by the client PC 10 in the processing of Step 206 is determined as the trigger operation, when receiving the trigger operation in the processing of Step 206, the client PC 10 transmits the client screen information and the operation log to the server 90. This allows the server 90 to acquire the screen that the operator of the helpdesk wishes to know.

It should be noted that, when an error occurs on the application 91 and when the server 90 illustrated in FIG. 2 generates the screen script for displaying a screen on which the error has occurred on the client PC 10, the server 90 determines the trigger operation based on the client screen information and the operation information that have been acquired so far (specifically, client screen information, operation information, and screen script table 520 described later).

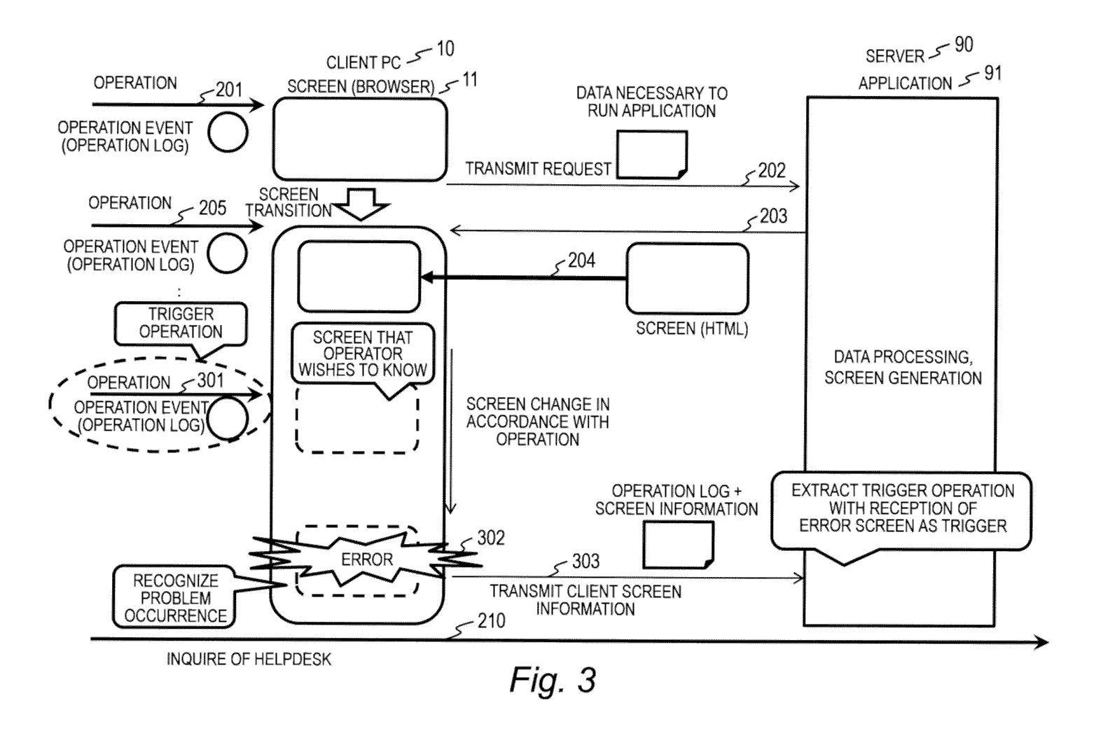

FIG. 3 is a second sequence diagram illustrating an outline of the embodiment of this invention.

With reference to FIG. 3, a description is made of a case where an error occurs on the client PC 10 side when this embodiment is applied to the information processing system. The same processing illustrated in FIG. 3 as the processing illustrated in FIG. 2 is denoted by the same reference numeral, and a description thereof is omitted.

After receiving the user's operation in the processing of Step 205, the browser 11 of the client PC 10 further receives the user's operation (301). When an error caused by the operation received in the processing of Step 301 occurs on the browser 11, the browser 11 displays the error screen (302). When an error occurs, the browser 11 transmits the operation log and the client screen information indicating the information on the currently-displayed error screen to the server 90 (303).

In the same manner as in FIG. 2, the operation that has caused the error or the client screen information obtained at the time of the operation is stored in the server 90, and hence the server 90 cannot display the screen that the operator of the helpdesk wishes to know.

In this embodiment, for example, in a case where the operation received by the client PC 10 in the processing of Step 301 is determined as the trigger operation, when receiving the trigger operation in the processing of Step 301, the client PC 10 transmits the client screen information and the operation log to the server 90. This allows the server 90 to acquire the screen that the operator of the helpdesk wishes to know.

It should be noted that, when receiving the client screen information indicating the information on the error screen from the client PC 10, the server 90 illustrated in FIG. 3 determines the trigger operation based on the client screen information, the operation information, and the screen script table 520 that have been acquired so far.

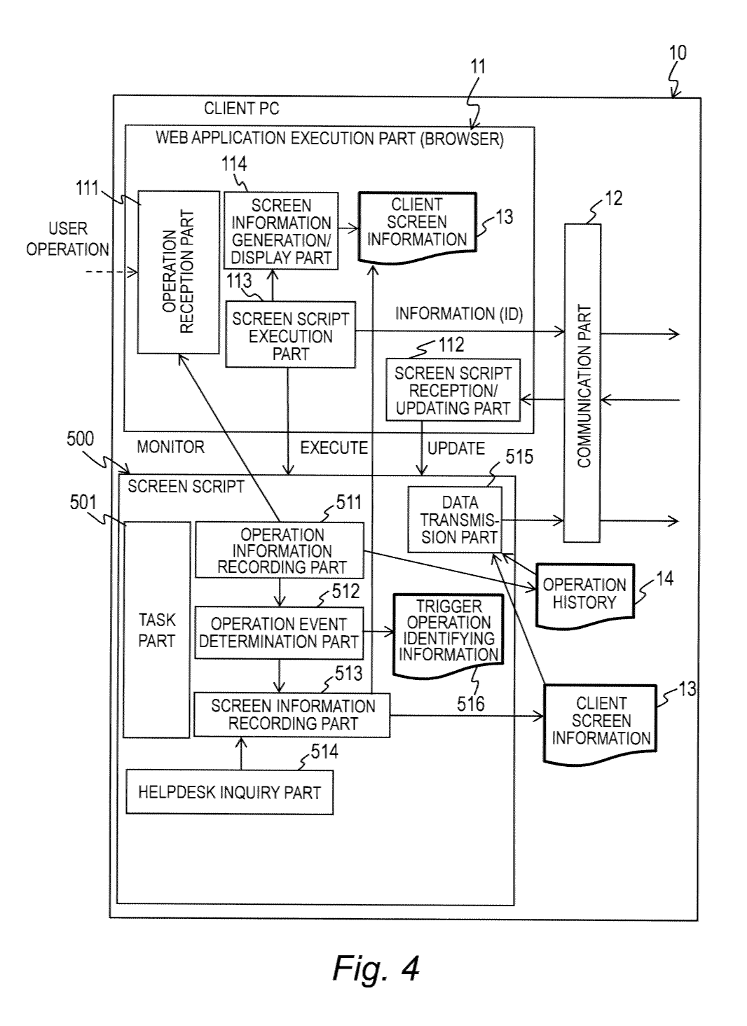

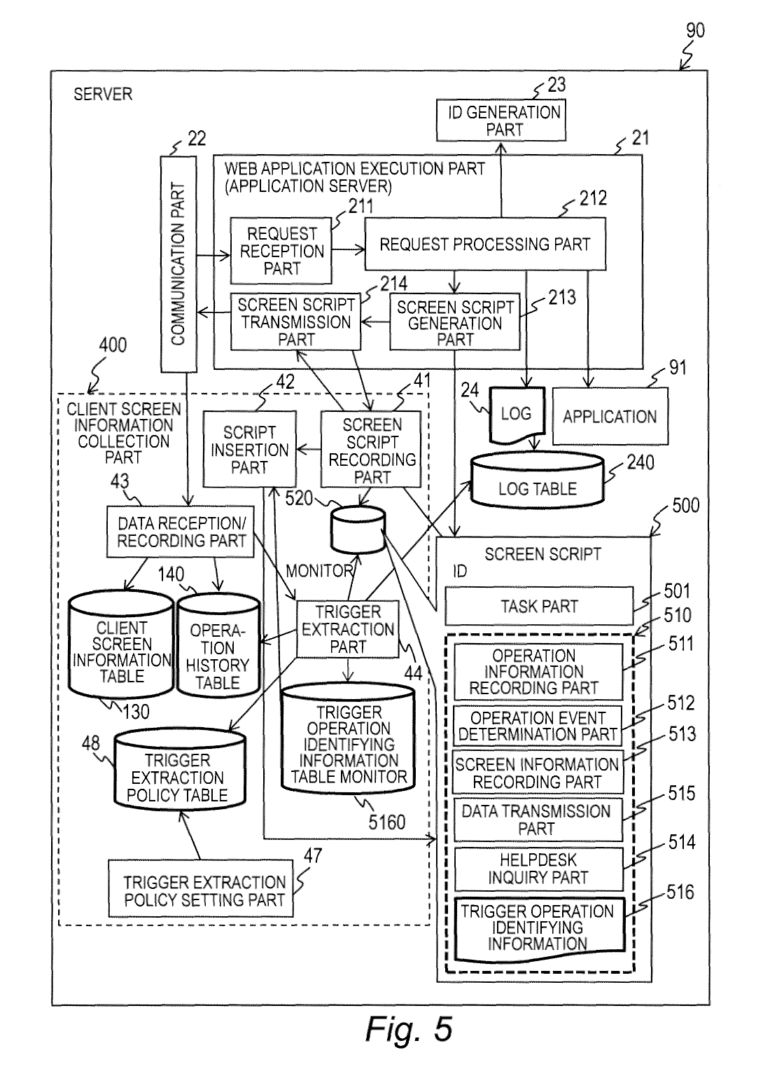

Next, a configuration of the information processing system according to this embodiment is described with reference to FIG. 4 and FIG. 5.

FIG. 4 is a functional block diagram of the client PC 10 according to the embodiment of this invention.

The client PC 10 includes a Web application execution part (browser) 11 and a communication part 12. The Web application execution part 11 generates the client screen by executing a screen script 500 transmitted by the server 90, and displays the generated client screen. Further, the Web application execution part 11 receives the user's operation performed on the client screen. The communication part 12 is an interface used to couple the client PC 10 to the network 80.

The Web application execution part 11 is described in detail.

The Web application execution part 11 includes an operation reception part 111, a screen script reception/updating part 112, a screen script execution part 113, and a screen information generation/display part 114.

The operation reception part 111 receives the user's operation performed on the client screen displayed by the client PC 10. The screen script reception/updating part 112 receives the screen script 500 received by the communication part 12, and updates the screen script to be executed to the received screen script 500. The screen script execution part 113 executes the screen script 500. The screen information generation/display part 114 generates client screen information 13 based on an execution result of the screen script 500 obtained by the screen script execution part 113, and displays the generated client screen information 13 as the client screen.

Next, the screen script 500 is described in detail.

The screen script 500 includes: a task part 501 serving as a script relating to a task provided to the client PC 10 by the server 90; and a client screen information transmission part 510 for transmitting the client screen information 13 and an operation history 14 to the server 90 when the client PC 10 receives the trigger operation, as illustrated in FIG. 5.

The client screen information transmission part 510 includes an operation information recording part 511, an operation event determination part 512, a screen information recording part 513, a helpdesk inquiry part 514, a data transmission part 515, and trigger operation identifying information 516.

The operation information recording part 511 acquires the user's operation received by the operation reception part 111, and records the acquired user's operation as the operation history 14 in a storage area (not shown) of the client PC 10. The operation event determination part 512 refers to the trigger operation identifying information 516 to determine whether or not the user's operation acquired by the operation information recording part 511 is the trigger operation identified by the trigger operation identifying information 516. When it is determined by the operation event determination part 512 that the user's operation is the trigger operation, the screen information recording part 513 acquires the client screen information 13 generated by the screen information generation/display part 114, and records the acquired client screen information 13 in a storage area (not shown) of the client PC 10. When receiving the user's operation for pressing a helpdesk inquiry button included in the client screen, the helpdesk inquiry part 514 controls the screen information recording part 513 to acquire the client screen information 13, and couples the client PC 10 to the operator terminal 70 placed in the helpdesk. When it is determined by the operation event determination part 512 that the user's operation is the trigger operation, the data transmission part 515 acquires, from the operation history 14, the operation history 14 of the user regarding the client screen on which the user has performed the trigger operation, and transmits the client screen information 13 and the acquired operation history 14 to the server 90.

FIG. 5 is a functional block diagram of the server 90 according to the embodiment of this invention.

The server 90 includes a Web application execution part 21, a communication part 22, an ID generation part 23, and a client screen information collection part 400.

When the communication part 22 receives the request transmitted from the client PC 10, the Web application execution part 21 executes the application 91 in response to the received request, generates the screen script 500, and transmits the generated screen script 500 to the client PC 10. The communication part 22 is an interface for coupling the server 90 to the network 80.

In order to associate the client screen information 13 and the operation history 14 that are collected from the client PC 10 with a log 24 output by the Web application execution part 21, the ID generation part 23 generates identification information (ID) on the screen script 500, and assigns the generated ID to the screen script 500 generated by a screen script generation part 213. The client screen information collection part 400 collects the client screen information 13 and the operation history 14 from the client PC 10, and determines the trigger operation when states of the client PC 10 and the server 90 come to the specific states.

The Web application execution part 21 is described in detail.

The Web application execution part 21 includes a request reception part 211, a request processing part 212, a screen script generation part 213, and a screen script transmission part 214. The request reception part 211 receives the request received by the communication part 22 from the client PC 10. The request processing part 212 executes the application 91 in response to the request received by the request reception part 211, to thereby execute the processing corresponding to the request. Further, the request processing part 212 outputs an operating behavior of its own as the log 24, and the output log 24 is recorded in a log table 240 of the server 90. The log table 240 is described in detail with reference to FIG. 9.

The screen script generation part 213 generates the task part 501 of the screen script 500 based on a processing result from the request processing part 212. The screen script transmission part 214 transmits the screen script 500 generated by the screen script generation part 213, into which the client screen information transmission part 510 is inserted by a script insertion part 42, to the client PC 10.

Next, the client screen information collection part 400 is described in detail.

The client screen information collection part 400 includes a screen script recording part 41, the script insertion part 42, a data reception/recording part 43, a trigger extraction part 44, a trigger extraction policy setting part 47, the screen script table 520, a client screen information table 130, an operation history table 140, a trigger operation identifying information table 5160, and a trigger extraction policy table 48.

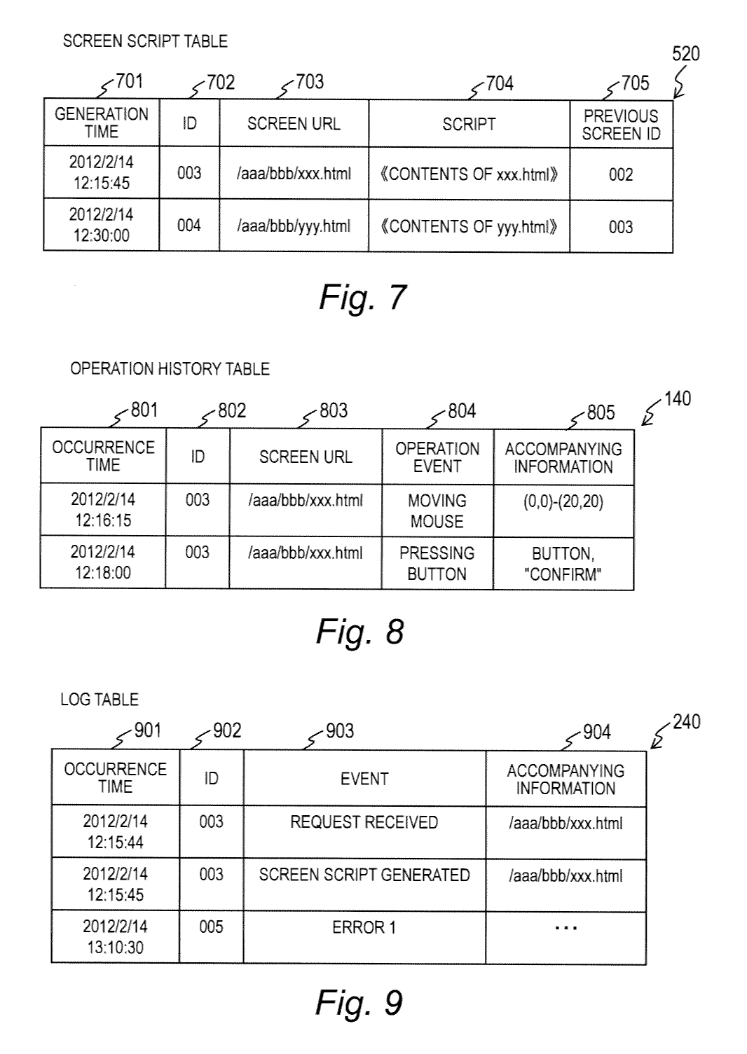

The screen script recording part 41 records the screen script 500 generated by the screen script recording part 41 in the screen script table 520. The screen script table 520 is described in detail with reference to FIG. 7. The script insertion part 42 inserts the client screen information transmission part 510 into the screen script 500 generated by the screen script generation part 213. The screen script transmission part 214 of the Web application execution part 21 transmits the screen script 500, into which the client screen information transmission part 510 is inserted by the script insertion part 42, to the client PC 10.

The data reception/recording part 43 receives the client screen information 13 and the operation history 14 received by the communication part 22 from the client PC 10, records the received client screen information 13 in the client screen information table 130, and records the received operation history 14 in the operation history table 140. The operation history table 140 is described in detail with reference to FIG. 8.

When detecting that at least one of the client PC 10 and the server 90 comes to the specific state, the trigger extraction part 44 determines a new trigger operation in accordance with the trigger extraction policy table 48. The trigger extraction policy setting part 47 registers a trigger extraction policy input by the user in the trigger extraction policy table 48. In the trigger extraction policy table 48, a policy for determining a new trigger operation by the trigger extraction part 44 is registered.

It should be noted that FIG. 5 illustrates an example in which the Web application execution part 21 and the client screen information collection part 400 are implemented on the same server 90, but as illustrated in FIG. 1, the Web application execution part 21 and the client screen information collection part 400 may be implemented on different computers.

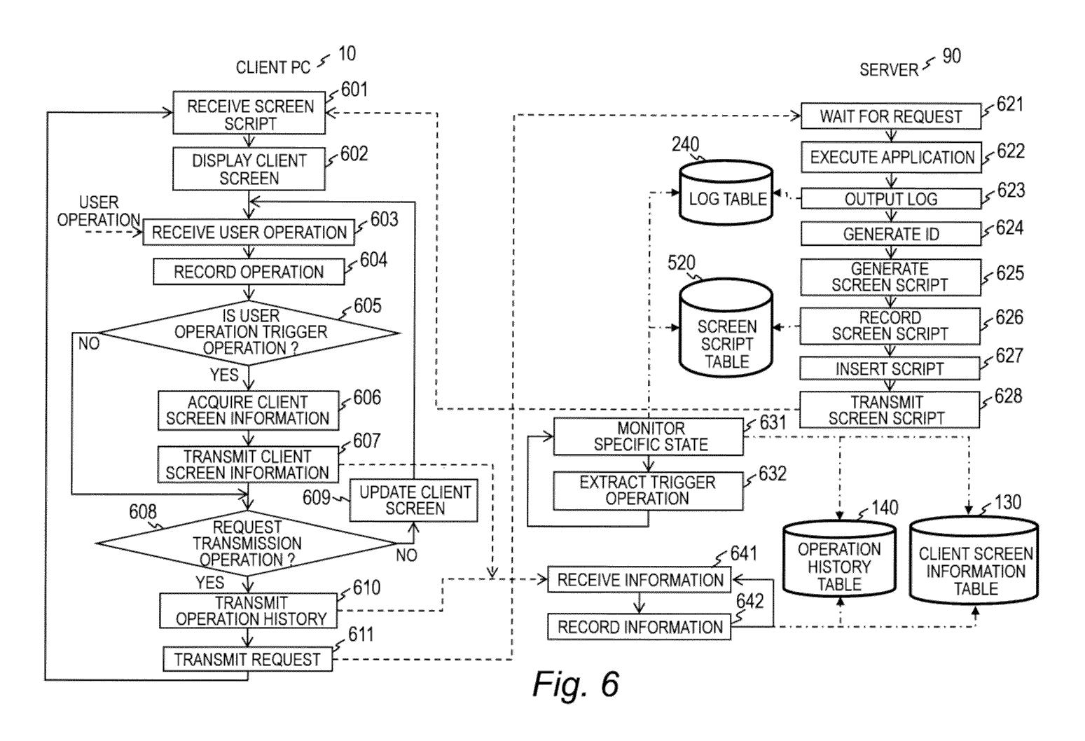

FIG. 6 is a flowchart of entire processing performed in the information processing system according to the embodiment of this invention.

In FIG. 6, the solid arrow indicates a flow of processing, the dotted arrow indicates a transmission destination of data, and the chain line indicates data to be referred to.

The processing performed by the client PC 10 is described.

First, the screen script reception/updating part 112 of the client PC 10 receives the screen script 500 transmitted by the server 90 (601). Then, the screen script execution part 113 executes the received screen script 500, and the screen information generation/display part 114 generates the client screen information 13, and displays the client screen of the generated client screen information 13 (602).

Subsequently, when the user inputs an operation on the displayed client screen, the operation reception part 111 receives the user's operation (603), and the operation information recording part 511 of the screen script 500 records the user's operation received by the operation reception part 111 as the operation history 14 (604). Then, the operation event determination part 512 of the screen script 500 determines whether or not the user's operation received by the operation reception part 111 is the trigger operation identified by the trigger operation identifying information 516 included in the screen script 500 (605).

When it is determined in the processing of Step 605 that the user's operation is the trigger operation, the screen information recording part 513 of the screen script 500 acquires the client screen information 13 generated by the screen information generation/display part 114 (606), while the data transmission part 515 transmits the client screen information 13 acquired by the screen information recording part 513 to the server 90 (607), and the procedure advances to the processing of Step 608. On the other hand, when it is determined in the processing of Step 605 that the user's operation is not the trigger operation, the procedure advances to the processing of Step 608 without executing the processing of Steps 606 and 607.

Subsequently, the client PC 10 determines whether or not the user's operation received by the operation reception part 111 is an operation (request transmission operation) set in advance as an operation for transmitting the request to the server 90 (608).

When it is determined in the processing of Step 608 that the user's operation is not the request transmission operation, the screen information generation/display part 114 updates the client screen information 13 so as to reflect the user's operation received by the operation reception part 111 on the client screen (609), and the procedure returns to the processing of Step 603.

On the other hand, when it is determined in the processing of Step 608 that the user's operation is the request transmission operation, the data transmission part 515 transmits the operation history 14 corresponding to the client screen information 13 for which the request transmission operation has been performed to the server 90 (610), and transmits the request corresponding to the request transmission operation to the server 90 (611), and the procedure returns to the processing of Step 601.

Next, the processing performed by the server 90 is described.

The server 90 stands by for the processing until the request reception part 211 receives the request transmitted from the client PC 10 (621). When the request reception part 211 receives the request, the request processing part 212 executes the application 91 corresponding to the received request (622), and outputs the log 24 indicating the operating behavior of its own (623). The output log 24 is recorded in the log table 240. Subsequently, the ID generation part 23 generates an ID to be assigned to the screen script 500 (624), and the screen script generation part 213 generates the screen script 500 based on the processing result from the request processing part 212 (625). The screen script recording part 41 of the client screen information collection part 400 records the screen script 500 generated by the screen script generation part 213 in the screen script table 520 (626). Then, the script insertion part 42 of the client screen information collection part 400 inserts the client screen information transmission part 510 into the screen script 500 recorded by the screen script recording part 41 (627), and the screen script transmission part 214 transmits the screen script 500 including the task part 501 and the client screen information transmission part 510 to the client PC 10 (628).

Further, the trigger extraction part 44 of the client screen information collection part 400 refers to the log table 240, the screen script table 520, and the operation history table 140 to monitor whether or not the client PC 10 and the server 90 have come to the specific states (631). When the client PC 10 and the server 90 come to the specific states, the trigger extraction part 44 refers to the client screen information 13 and the operation history 14 to determine a new trigger operation (632), and the procedure returns to the processing of Step 631.

Further, the data reception/recording part 43 of the client screen information collection part 400 receives the client screen information 13 and the operation history 14 transmitted from the client PC 10 in the processing of Steps 607 and 610 (641). Then, the data reception/recording part 43 records the received client screen information 13 in the client screen information table 130, and records the received operation history 14 in the operation history table 140 (642).

FIG. 7 is an explanatory diagram of the screen script table 520 according to the embodiment of this invention.

The screen script table 520 includes a generation time 701, an ID 702, a screen URL 703, a script 704, and a previous screen ID 705.

In the generation time 701, a time at which the screen script 500 is generated is registered. In the ID 702, an ID assigned to the screen script 500 by the ID generation part 23 is registered. In the screen URL 703, a URL of an access destination is registered. The screen scripts 500 having the same URL registered in the screen URL 703 generate the same client screen. In the script 704, contents of the screen script 500 are registered. In the previous screen ID 705, an ID assigned to a screen script 500 immediately before the screen script 500 of this record is registered.

FIG. 8 is an explanatory diagram of the operation history table 140 according to the embodiment of this invention.

The operation history table 140 includes an occurrence time 801, an ID 802, a screen URL 803, an operation event 804, and accompanying information 805.

In the occurrence time 801, a time at which the operation reception part 111 of the client PC 10 receives a user operation is registered. In the ID 802, an ID assigned to the screen script 500 being executed when the operation reception part 111 receives the user operation is registered. In the screen URL 803, the URL of the access destination of the screen script 500 identified by the ID registered in the ID 802 is registered. In the operation event 804, a type of user operation received by the operation reception part 111 is registered. In the accompanying information 805, information accompanying the user operation received by the operation reception part 111 is registered. For example, coordinates indicating how a mouse has moved are registered in the accompanying information 805 of the record in which “moving mouse” is registered in the operation event 804, and a type of operated button is registered in the accompanying information 805 of the record in which “pressing button” is registered in the operation event 804.

FIG. 9 is an explanatory diagram of the log table 24 according to the embodiment of this invention.

The log table 240 includes an occurrence time 901, an ID 902, an event 903, and accompanying information 904.

In the occurrence time 901, a time at which the log 24 is output from the request processing part 212 is registered. In the ID 902, the ID of the screen script 500 included in the request corresponding to the processing being executed by the request processing part 212 when the request processing part 212 outputs the log 24 is registered. It should be noted that, when transmitting the request, the client PC 10 transmits the request by including therein the screen URL and the ID of the screen script 500 being executed.

In the event 903, a type of processing being executed by the request processing part 212 when the request processing part 212 outputs the log 24 is registered. In the accompanying information 904, the screen URL or the like included in the request corresponding to the processing being executed by the request processing part 212 when the request processing part 212 outputs the log 24 is registered.

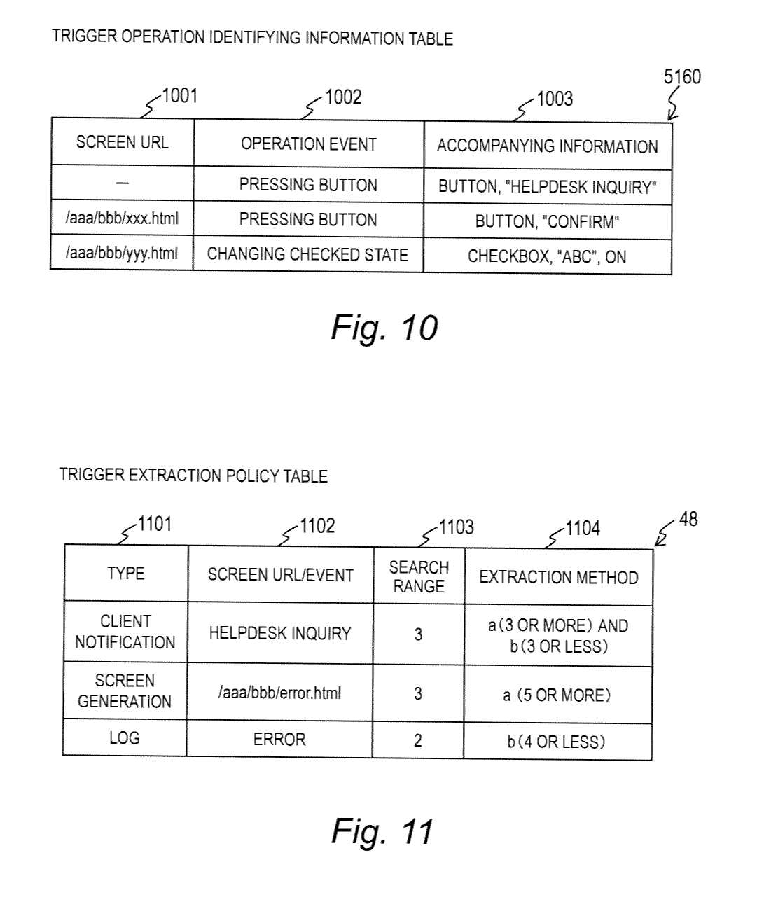

FIG. 10 is an explanatory diagram of the trigger operation identifying information table 5160 according to the embodiment of this invention.

The trigger operation identifying information table 5160 includes a screen URL 1001, an operation event 1002, and accompanying information 1003.

In the screen URL 1001, the URL of the access destination of the screen script 500 is registered. In the operation event 1002, a type of an operation to be the trigger operation is registered. In the accompanying information 1003, information accompanying the trigger operation is registered. For example, a type of button to be operated is registered in the accompanying information 1003 of the record in which “pressing button” is registered in the operation event 1002.

FIG. 11 is an explanatory diagram of the trigger extraction policy table 48 according to the embodiment of this invention.

The trigger extraction policy table 48 includes a type 1101, a screen URL/event 1102, a search range 1103, and an extraction method 1104.

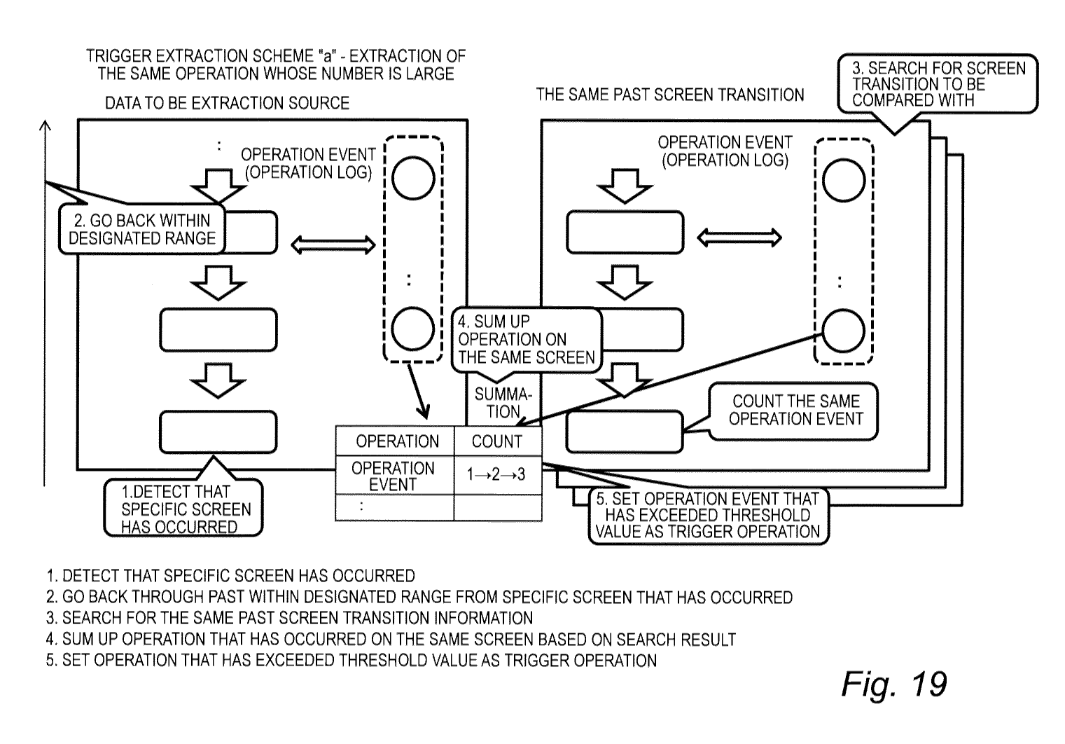

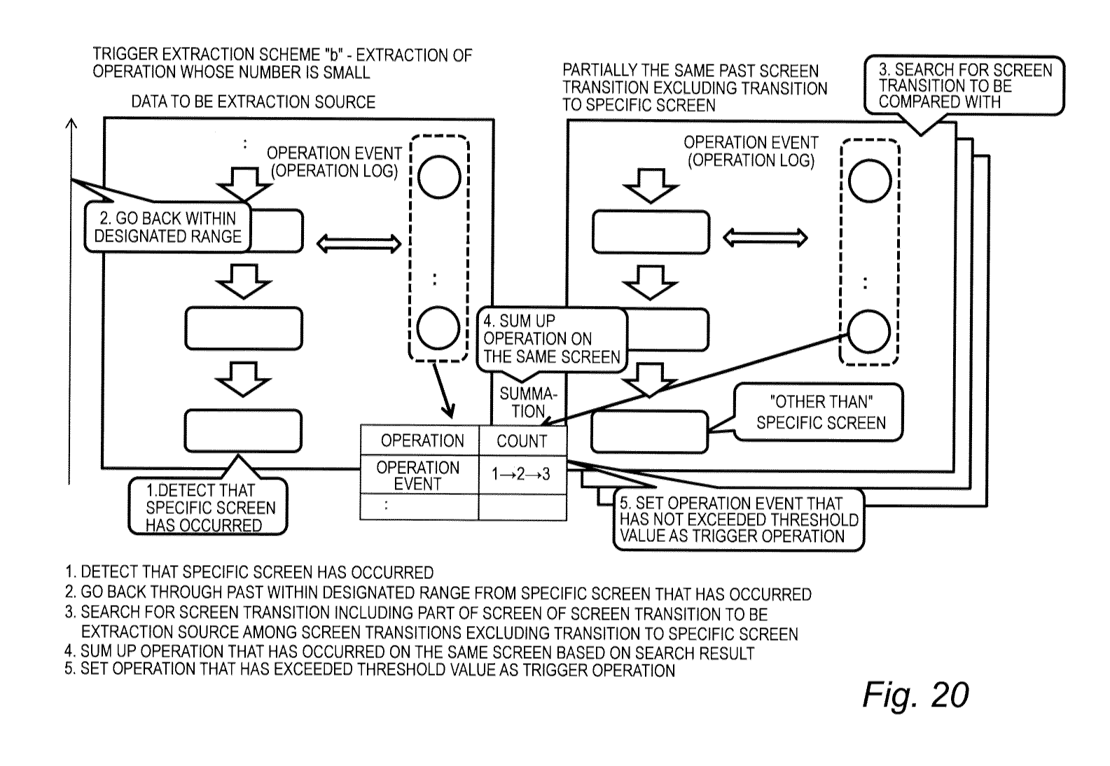

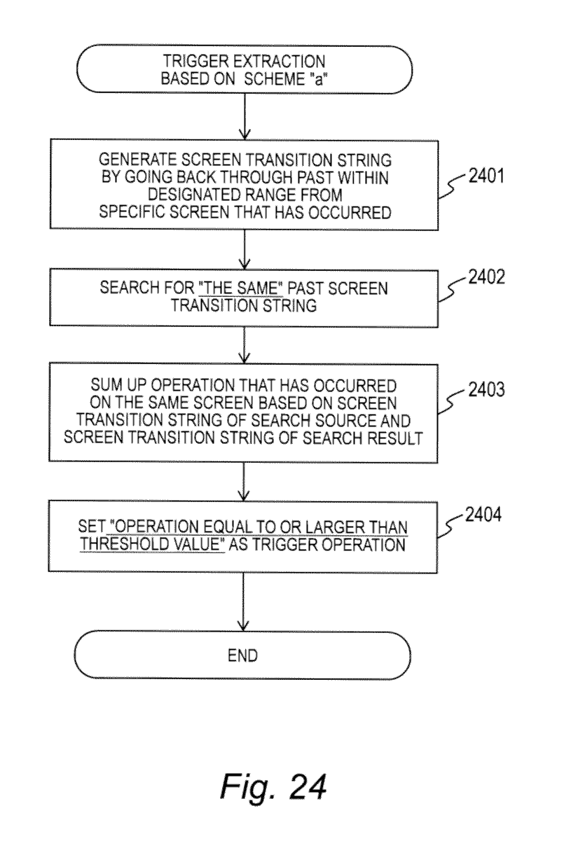

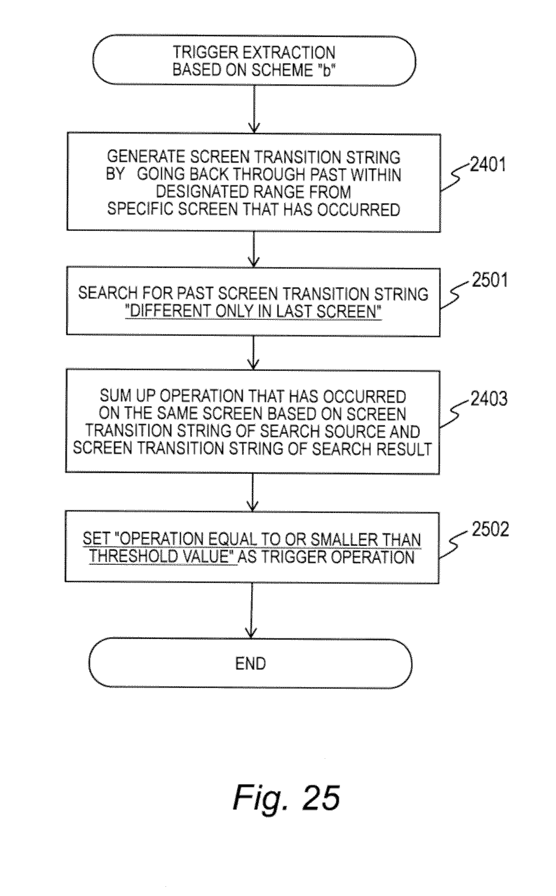

In the type 1101, a type of timing at which the trigger extraction part 44 starts execution of trigger extraction processing is registered. In the screen URL/event 1102, the screen URL of the screen script 500 being executed by the client PC 10 when the user's operation (trigger extraction operation) that causes the trigger extraction part 44 to start the execution of the trigger extraction processing is performed or the type of processing being executed by the request processing part 212 when the request processing part 212 outputs the log 24 is registered. In the search range 1103, a search range of the client screen information 13 acquired when the trigger operation is determined is registered. In the extraction method 1104, a type of trigger extraction scheme for determining the trigger operation and a threshold value used for the trigger extraction scheme are registered. It should be noted that the trigger extraction scheme according to this embodiment includes a trigger extraction scheme “a” and a trigger extraction scheme “b”, which are described in detail with reference to FIG. 19, FIG. 20, FIG. 24, and FIG. 25.

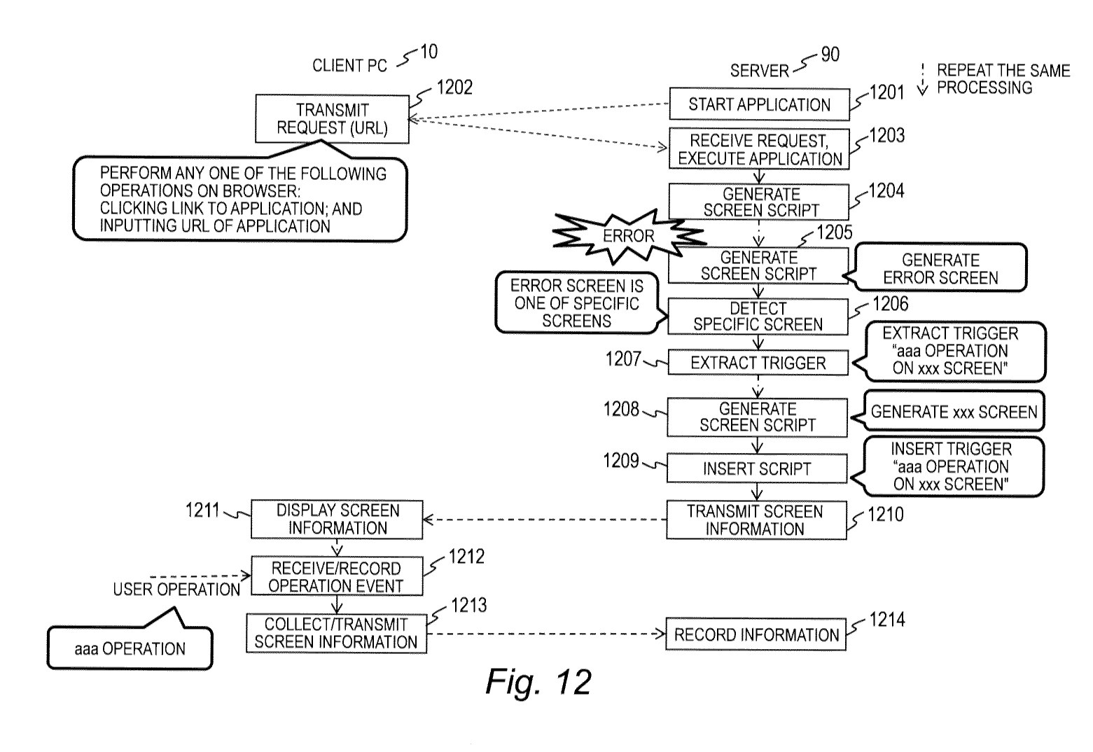

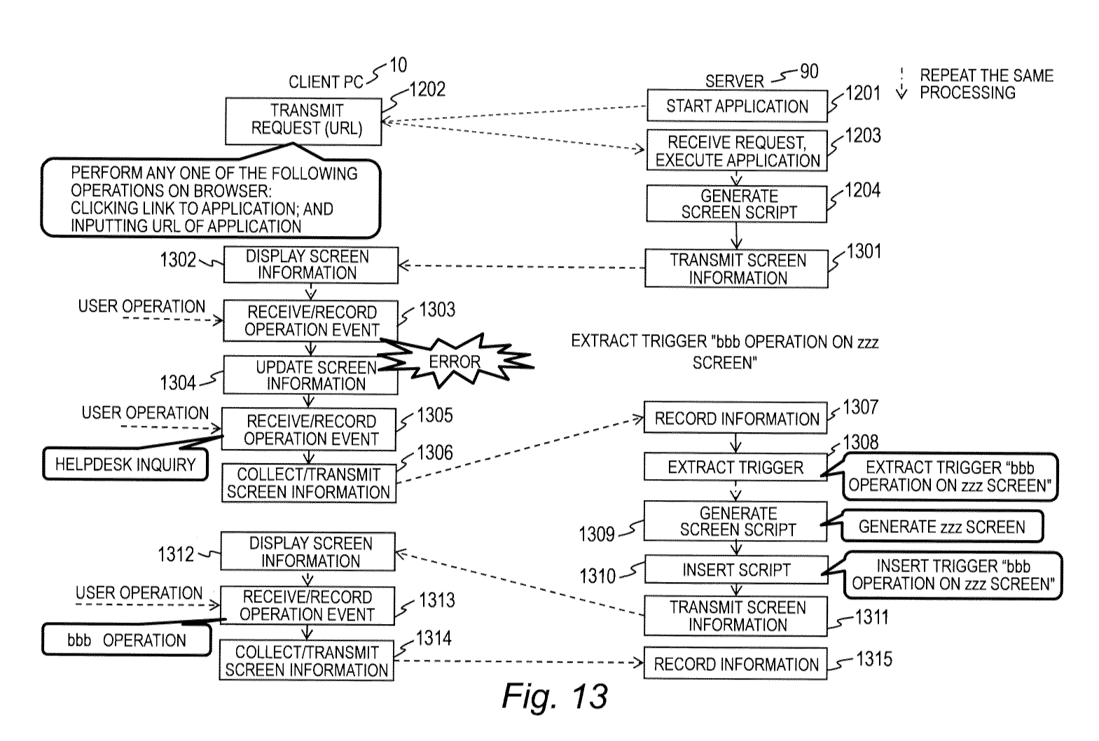

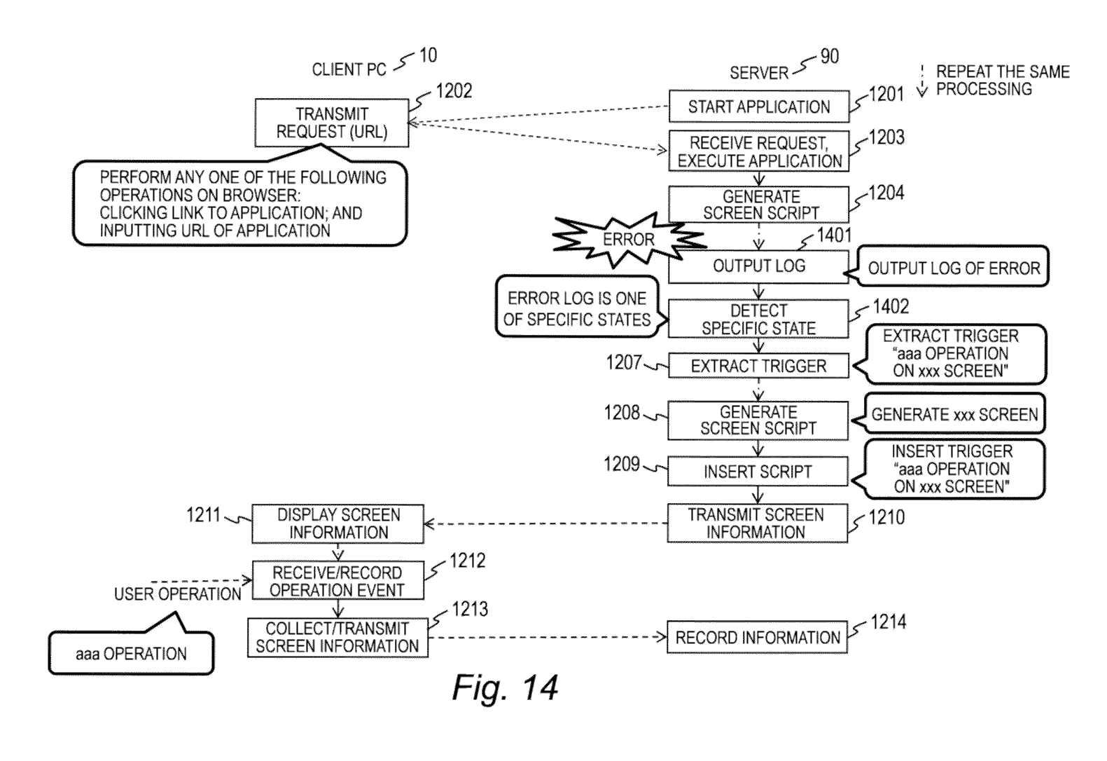

Next, the timing at which the trigger extraction part 44 starts the execution of the trigger extraction processing is described with reference to FIG. 12 to FIG. 14. The timing to start the execution of the trigger extraction processing is a timing at which the trigger extraction part 44 detects that at least one of the client PC 10 and the server 90 comes to the specific state. For example, the specific state of the client PC 10 indicates a case where the client PC 10 receives the trigger extraction operation on a specific screen as illustrated in FIG. 13, and the specific state of the server 90 indicates a case where the server 90 generates a specific screen script 500 for displaying a specific screen as illustrated in FIG. 12, or a case where the server 90 outputs a specific log 24 as illustrated in FIG. 14.

FIG. 12 is an explanatory diagram of the trigger extraction processing executed when the server 90 according to the embodiment of this invention generates the specific screen script 500.

First, the request processing part 212 of the server 90 launches the application 91, and starts the processing of the application 91 (1201). Subsequently, when the operation reception part 111 of the client PC 10 receives a specific user operation, the client PC 10 transmits the request to the server 90 (1202). Examples of the specific user operation include an operation for clicking a link to the application 91 on the browser 11 and an operation for inputting the URL of the application 91 on the browser 11.

When the request reception part 211 of the server 90 receives the request transmitted from the client PC 10, the request processing part 212 executes the processing corresponding to the received request (1203), generates the screen script 500 based on the execution result (1204), and transmits the generated screen script 500 to the client PC 10.

In this manner, the server 90 executes the application 91 in response to the request received from the client PC 10, and repeatedly executes processing for generating the screen script 500 based on the execution result.

When an error occurs during the execution of the above-mentioned processing, the screen script generation part 213 generates the screen script 500 for displaying the error screen as the client screen (1205). The generation of the screen script 500 for the error screen is registered in the trigger extraction policy table 48, and hence the trigger extraction part 44 detects the specific screen, detects that the server 90 has come to the specific state (1206), and executes the trigger extraction processing (1207). It is assumed that “aaa operation on xxx screen” is extracted as the trigger operation in the trigger extraction processing.

After executing the trigger extraction processing in the processing of Step 1207, the server 90 repeatedly executes processing for generating the screen script 500 based on the execution result of the processing performed in response to the request received from the client PC 10.

When the screen script generation part 213 generates the screen script 500 for displaying the xxx screen (1208), the script insertion part 42 inserts the client screen information transmission part 510 including trigger operation identifying information indicating “aaa operation on xxx screen” into the screen script 500 generated in the processing of Step 1208 (1209), and transmits the screen script 500 to the client PC 10 (1210).

When receiving the screen script 500 transmitted in the processing of Step 1210, the client PC 10 executes the screen script 500, and displays the xxx screen as the client screen (1211). When the operation reception part 111 receives the aaa operation while the xxx screen is being displayed (1212), the client PC 10 acquires the client screen information 13 on the client screen being displayed, and transmits the acquired client screen information 13 to the server 90 (1213).

When receiving the client screen information 13, the server 90 stores the received client screen information 13 in the client screen information table 130 (1214).

By the above-mentioned processing, when the screen script generation part 213 generates the screen script 500 for displaying the error screen, the trigger extraction part 44 determines that the server 90 has come to the specific state, and determines a new trigger operation.

FIG. 13 is an explanatory diagram of the trigger extraction processing executed when the client PC 10 according to the embodiment of this invention receives the trigger extraction operation on the specific screen. It should be noted that the same processing illustrated in FIG. 13 as the processing illustrated in FIG. 12 is denoted by the same reference numeral, and a description thereof is omitted.

The server 90 transmits the screen script 500 generated in the processing of Step 1204 to the client PC 10 (1301).

When receiving the screen script 500 transmitted in the processing of Step 1301, the client PC 10 executes the screen script 500, and displays the client screen (1302). Then, the operation reception part 111 of the client PC 10 receives the user operation on the displayed client screen, and records the received user operation in the operation history 14 (1303). Then, the client PC 10 updates the client screen information 13 so as to reflect the user operation received by the operation reception part 111 (1304), and it is assumed that an error occurs in this update processing.

In this case, the client PC 10 receives the operation for pressing the helpdesk inquiry button included in the client screen being displayed, and records the received operation for pressing in the operation history 14 (1305). In the trigger operation identifying information shown in FIG. 10, the operation for pressing the helpdesk inquiry button is registered as the trigger operation, and hence the client PC 10 detects the trigger operation, acquires the client screen information 13 being displayed, and transmits the acquired client screen information 13 to the server 90 (1306). It should be noted that the helpdesk inquiry button is displayed on any client screen, and the operation for pressing the helpdesk inquiry button is the trigger operation.

When receiving the client screen information 13 transmitted in the processing of Step 1306, the server 90 records the received client screen information 13 in the client screen information table 130 (1307). Further, the received client screen information 13 is one transmitted by the operation for pressing the helpdesk inquiry button, and includes the notification on helpdesk inquiry as well. The notification on the helpdesk inquiry is registered in the trigger extraction policy table 48 shown in FIG. 11, and hence the trigger extraction part 44 determines that the client PC 10 has received the trigger extraction operation, and executes the trigger extraction processing (1308). It is assumed that “bbb operation on zzz screen” is extracted as the trigger operation in the trigger extraction processing.

After executing the trigger extraction processing in the processing of Step 1308, the server 90 repeatedly executes processing for generating the screen script 500 based on the execution result of the processing performed in response to the request received from the client PC 10.

When the screen script generation part 213 generates the screen script 500 for displaying the zzz screen (1309), the script insertion part 42 inserts the client screen information transmission part 510 including the trigger operation identifying information indicating “bbb operation on zzz screen” into the screen script 500 generated in the processing of Step 1308 (1310), and transmits the screen script 500 to the client PC 10 (1311).

When receiving the screen script 500 transmitted in the processing of Step 1311, the client PC 10 executes the screen script 500, and displays the zzz screen as the client screen (1312). When the operation reception part 111 receives the bbb operation while the zzz screen is being displayed (1313), the client PC 10 acquires the client screen information 13 on the client screen being displayed, and transmits the acquired client screen information 13 to the server 90 (1314).

When receiving the client screen information 13, the server 90 stores the received client screen information 13 in the client screen information table 130 (1315).

By the above-mentioned processing, when the client PC 10 receives the trigger extraction operation, the trigger extraction part 44 determines that the client PC 10 has come to the specific state, and determines a new trigger operation.

FIG. 14 is an explanatory diagram of the trigger extraction processing executed when the server 90 according to the embodiment of this invention outputs the specific log 24. The same processing illustrated in FIG. 14 as the processing illustrated in FIG. 12 is denoted by the same reference numeral, and a description thereof is omitted.

Each time the request processing part 212 executes the processing corresponding to the request, the request processing part 212 outputs the log 24. It is assumed that the request processing part 212 has output the log 24 indicating an error (1401). In this case, the output of the log 24 indicating the error is registered as the specific state of the server 90 in the trigger extraction policy table 48 shown in FIG. 11, and hence the trigger extraction part 44 detects that the server 90 has come to the specific state (1402). Then, the trigger extraction part 44 executes the trigger extraction processing in the processing of Step 1207. It should be noted that the subsequent processing is the same as the processing illustrated in FIG. 12, and hence a description thereof is omitted.

By the above-mentioned processing, when the server 90 outputs the specific log 24, the trigger extraction part 44 determines that the server 90 has come to the specific state, and determines a new trigger operation.

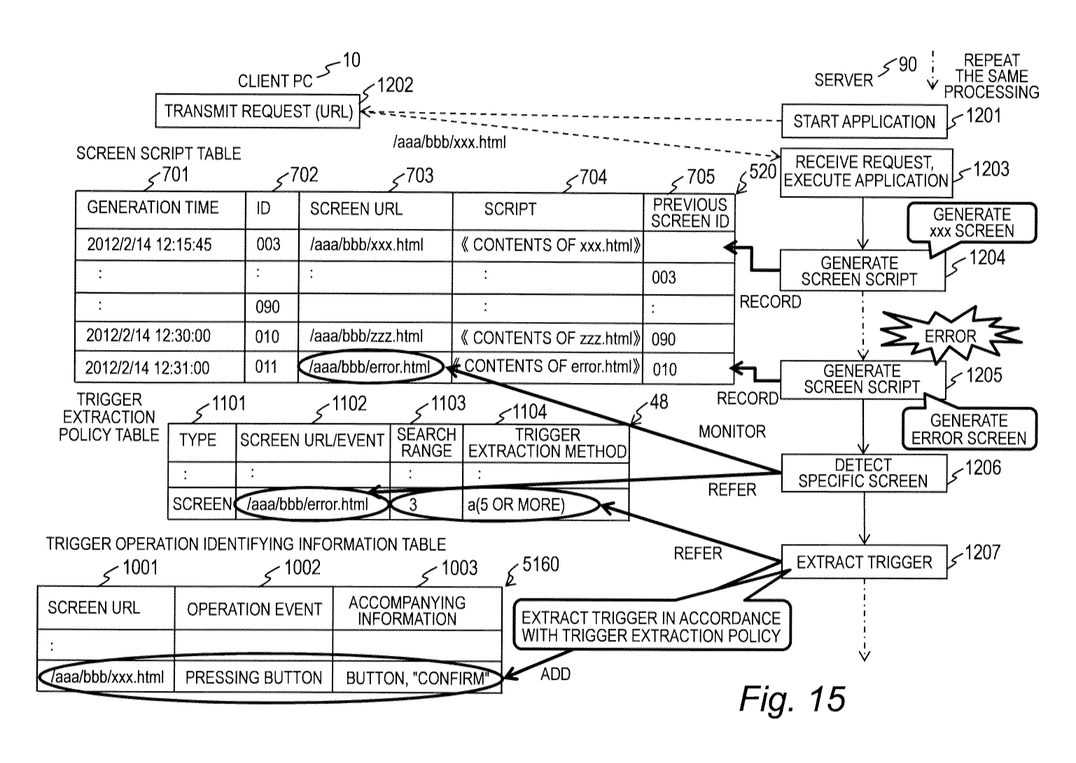

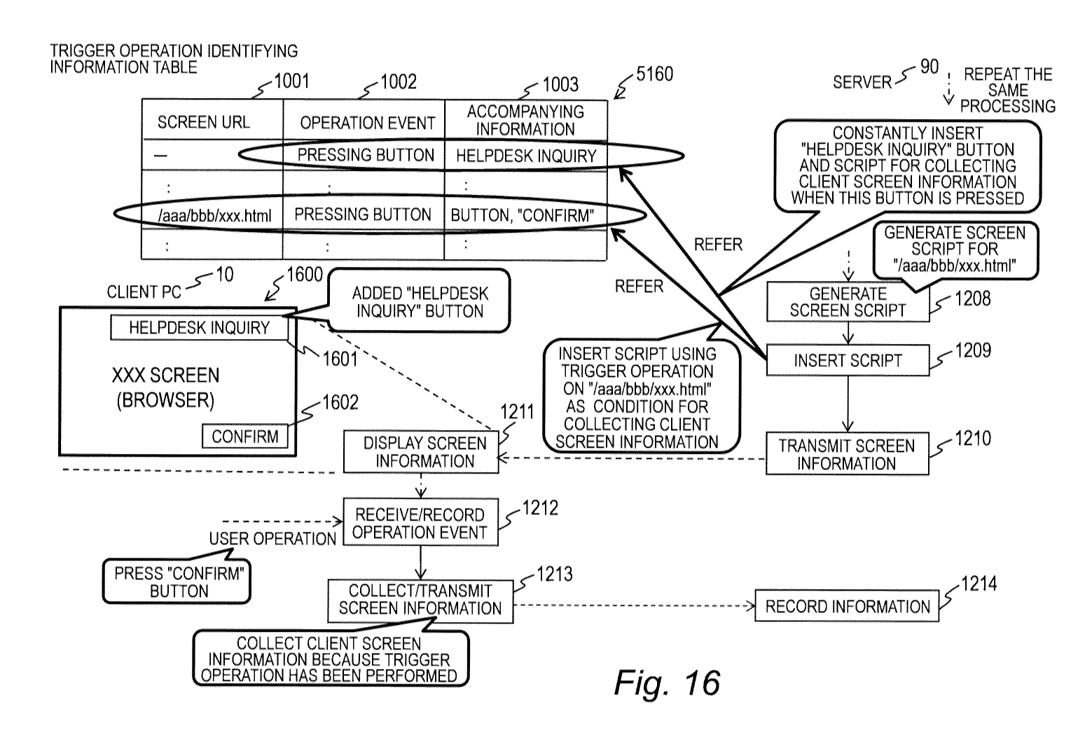

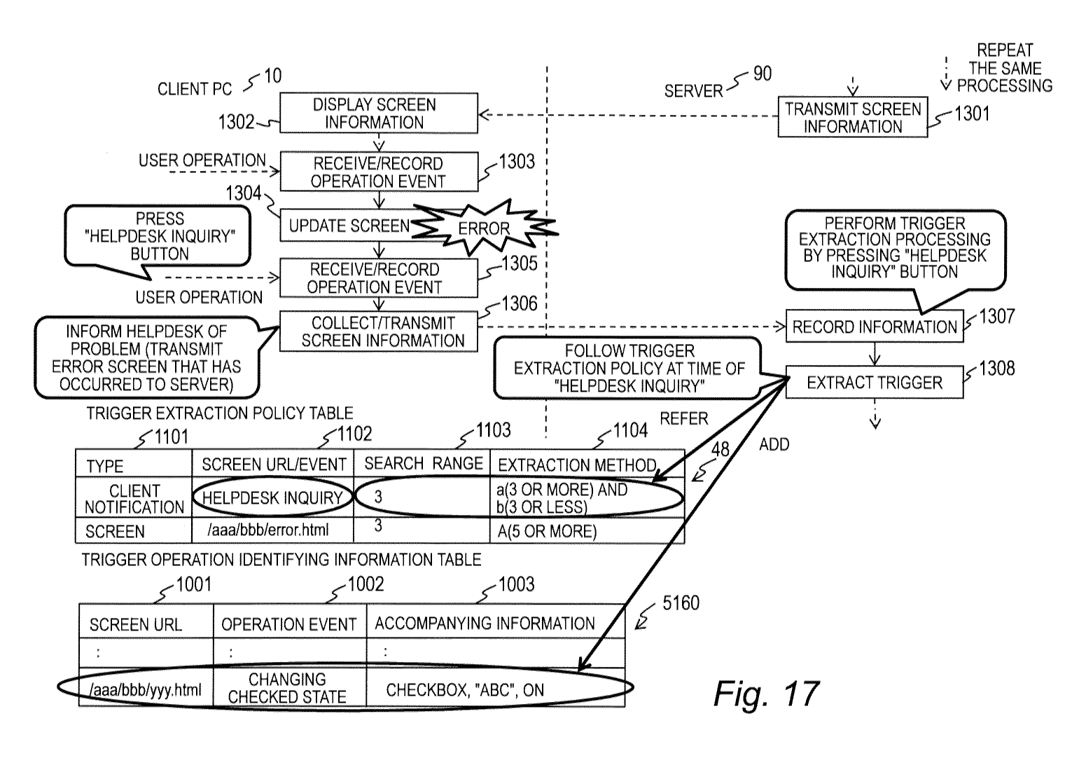

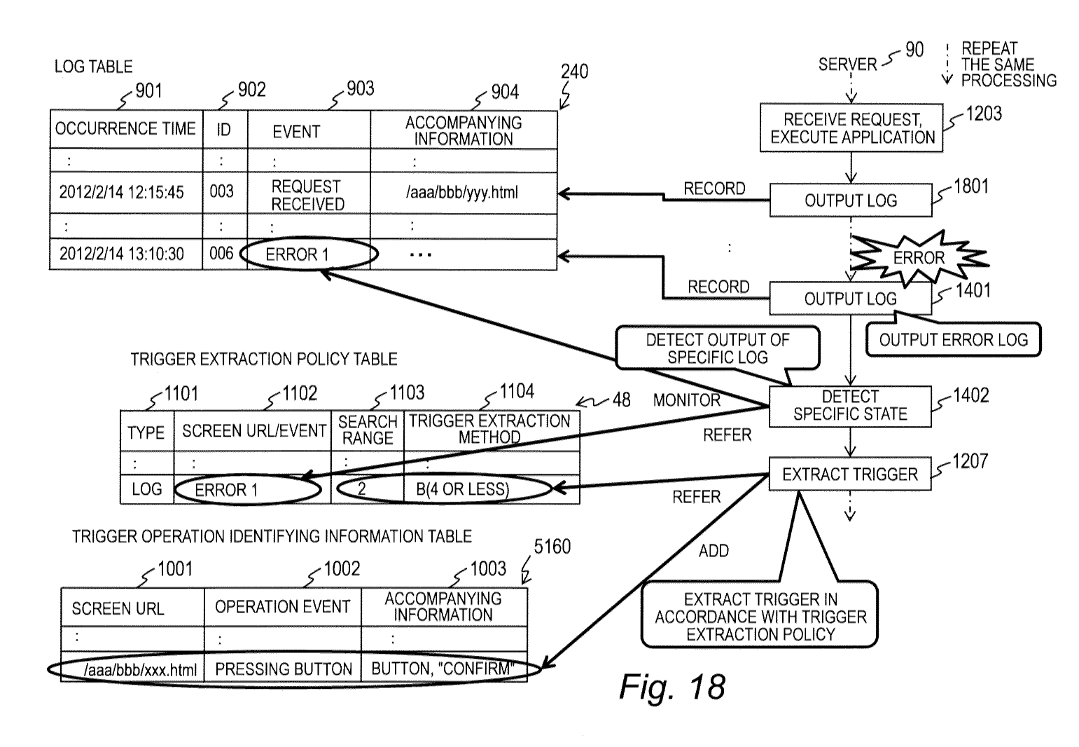

Next, a specific example of the timing to start the execution of the trigger extraction processing is described with reference to FIG. 15, FIG. 17, and FIG. 18, and a specific example of trigger acquisition processing is described with reference to FIG. 16.

FIG. 15 is a specific explanatory diagram of the trigger extraction processing executed when the server 90 according to the embodiment of this invention generates the specific screen script 500. The same processing illustrated in FIG. 15 as the processing illustrated in FIG. 12 is denoted by the same reference numeral, and a description thereof is omitted.

When the screen script generation part 213 generates the screen script 500 for the xxx screen in the processing of Step 1204, the screen script generation part 213 adds a new record to the screen script table 520, and the ID generation part 23 generates an ID “003” to be assigned to the screen script 500. Then, the screen script generation part 213 registers a generation time of the screen script 500 in the generation time 701 of the added record, registers the generated ID “003” in the ID 702 of the added record, registers the URL of the access destination of the screen script 500 in the screen URL 703 of the added record, and registers the contents of the screen script 500 in the script 704 of the added record. It should be noted that the screen script 500 generated immediately before the screen script 500 of this added record does not exist, and hence the screen script generation part 213 registers nothing in the previous screen ID 705 of the added record.

When the screen script generation part 213 generates the screen script 500 for the error screen in the processing of Step 1205, the screen script generation part 213 adds a new record to the screen script table 520, and the ID generation part 23 generates an ID “011” to be assigned to the screen script 500. Then, the screen script generation part 213 registers the generation time of the screen script 500 in the generation time 701 of the added record, registers the generated ID “011” in the ID 702 of the added record, registers the URL of the access destination of the screen script 500 in the screen URL 703 of the added record, and registers the contents of the screen script 500 in the script 704 of the added record. In the previous screen ID 705 of the added record, the screen script generation part 213 registers the ID “010” of the screen script generated immediately before the screen script 500 of this added record.

The trigger extraction part 44 monitors whether or not the URL of the access destination of the specific screen is registered in the screen URL 703 of the screen script table 520. Here, in the screen URL/event 1102 of the trigger extraction policy table 48, “/aaa/bbb/error.html” is registered in advance as the URL of the access destination of the specific screen. Therefore, “/aaa/bbb/error.html” is registered in the screen URL 703 of the record added to the screen script table 520 in the processing of Step 1205, and hence the trigger extraction part 44 detects the specific screen in the processing of Step 1206.

When detecting the specific screen in the processing of Step 1206, the trigger extraction part 44 determines that the server 90 has come to the specific state, and executes the trigger extraction processing in the processing of Step 1207. Specifically, the trigger extraction part 44 executes the trigger extraction processing by using the search range 1103 and the extraction method 1104 of the record in which “/aaa/bbb/error.html” is registered in the screen URL/event 1102 of the trigger extraction policy table 48. In the trigger extraction processing, an operation for pressing a “confirm” button on a client display screen displayed by the screen script 500 whose access destination has the URL “/aaa/bbb/xxx.html” is determined as the trigger operation. The trigger extraction part 44 adds a new record to the trigger operation identifying information table 5160, registers “/aaa/bbb/xxx.html” in the screen URL 1001 of the added record, registers “pressing button” in the operation event 1002 of the added record, and registers “button, ‘confirm’” in the accompanying information 1003.

By the above-mentioned processing, the trigger extraction part 44 refers to the screen script table 520 to detect that the specific screen has been generated and detect that the server 90 has come to the specific state, and executes the trigger extraction processing. Further, the trigger extraction part 44 executes the trigger extraction processing based on the trigger extraction policy table 48, and registers the trigger operation determined in the trigger extraction processing in the trigger operation identifying information table 5160.

FIG. 16 is a specific explanatory diagram of the trigger acquisition processing according to the embodiment of this invention. The same processing illustrated in FIG. 16 as the processing illustrated in FIG. 12 is denoted by the same reference numeral, and a description thereof is omitted.

In the processing of Step 1208, the screen script generation part 213 generates the screen script 500 whose access destination has the URL “/aaa/bbb/xxx.html”.

Subsequently, in the processing of Step 1209, the script insertion part 42 refers to the trigger operation identifying information table 5160 to insert a script to be the client screen information transmission part 510 into the screen script 500 generated by the screen script generation part 213. Specifically, the script insertion part 42 inserts a script for displaying a helpdesk inquiry button 1601 on the client screen. Further, when the helpdesk inquiry button 1601 is pressed, the script insertion part 42 acquires the client screen information 13 being displayed, and inserts the script to be the client screen information transmission part 510 for transmitting the acquired client screen information 13 to the server 90. Further, when a “confirm” button 1602 is pressed on the client screen displayed by the screen script 500 whose access destination has the URL “/aaa/bbb/xxx.html”, the script insertion part 42 acquires the client screen information 13 being displayed, and inserts the script to be the client screen information transmission part 510 for transmitting the acquired client screen information 13 to the server 90.

In the processing of Step 1210, the screen script transmission part 214 transmits the screen script 500 into which the script has been inserted by the script insertion part 42 to the client PC 10.

In the processing of Step 1211, the screen script execution part 113 of the client PC 10 executes the received screen script 500, and the screen information generation/display part 114 displays a client screen 1600 based on the execution result from the screen script execution part 113. The client screen 1600 displayed in the processing of Step 1211 includes the helpdesk inquiry button 1601 and the “confirm” button 1602.

In the processing of Step 1212, the operation reception part 111 receives the user's operation for pressing the “confirm” button 1602, and the operation information recording part 511 records this operation. Further, the operation event determination part 512 determines that the operation received in the processing of Step 1212 is the trigger operation, and in the processing of Step 1213, the data transmission part 515 acquires the client screen information 13 of the client screen 1600 being displayed, and transmits the acquired client screen information 13 to the server 90.

In the processing of Step 1214, when receiving the client screen information 13 transmitted in the processing of Step 1213, the server 90 records the received client screen information 13 in the client screen information table 130.

By the above-mentioned processing, the script insertion part 42 refers to the trigger operation identifying information table 5160 to insert the client screen information transmission part 510 into the screen script 500 generated by the screen script generation part 213. When it is determined that the trigger operation has been performed by the client screen information transmission part 510, the client PC 10 acquires the client screen information 13 on the client screen being displayed, and transmits the acquired client screen information 13 to the server 90.

FIG. 17 is an explanatory diagram of a specific example of the trigger extraction processing executed when the client PC 10 according to the embodiment of this invention receives the trigger extraction operation on the specific screen. The same processing illustrated in FIG. 17 as the processing illustrated in FIG. 13 is denoted by the same reference numeral, and a description thereof is omitted.

It is assumed that an error occurs when the client screen is updated in the processing of Step 1304.

In the processing of Step 1305, the operation reception part 111 of the client PC 10 receives the user's operation for pressing the helpdesk inquiry button 1601, and the operation information recording part 511 records this operation in the operation history 14.

The operation for pressing the helpdesk inquiry button 1601 is the trigger operation, and hence in the processing of Step 1306, the client PC 10 transmits the client screen information 13 on the client screen being displayed to the server 90.

In the processing of Step 1307, when receiving the client screen information 13 by the user's operation for pressing the helpdesk inquiry button 1601, the server 90 records the received client screen information 13 in the client screen information table 130 and detects that the client PC 10 has come to the specific state, and in the processing of Step 1308, the trigger extraction part 44 refers to the trigger extraction policy table 48 at a time of the operation for pressing the helpdesk inquiry button to execute the trigger extraction processing. Specifically, the trigger extraction part 44 executes the trigger extraction processing by using the search range 1103 and the extraction method 1104 of the record in which “helpdesk inquiry” is registered in the screen URL/event 1102 of the trigger extraction policy table 48. In the trigger extraction processing, an operation for changing a state of a checkbox “ABC” to an “ON” state on the client display screen displayed by the screen script 500 whose access destination has the URL “/aaa/bbb/yyy.html” is determined as the trigger operation. The trigger extraction part 44 adds a new record to the trigger operation identifying information table 5160, registers “/aaa/bbb/yyy.html” in the screen URL 1001 of the added record, registers “changing checked state” in the operation event 1002 of the added record, and registers “checkbox, ‘ABC’, ON” in the accompanying information 1003.

By the above-mentioned processing, the server 90 detects that the client PC 10 has come to the specific state, and executes the trigger extraction processing.

FIG. 18 is an explanatory diagram of a specific example of the trigger extraction processing executed when the server 90 according to the embodiment of this invention outputs the specific log 24.

When the request reception part 211 receives the request, the request processing part 212 outputs the log 24 indicating that the request has been received. In this case, the request processing part 212 adds a new record to the log table 240, registers an output time of the log 24 in the occurrence time 901 of the added record, registers the ID “003” of the screen script 500 included in the received request in the ID 902, registers the event name “request received” indicating that the request has been received in the event 903, and registers the screen URL “/aaa/bbb/yyy.html” included in the request in the accompanying information 904. It should be noted that the request includes the ID “003” of the screen script 500 for displaying the client screen on which the operation for transmitting the request has been received and the URL (screen URL) “/aaa/bbb/yyy.html” of the access destination of the screen script 500.

When an error occurs while the request processing part 212 is executing the processing corresponding to the request including the ID “006” of the screen script 500, the request processing part 212 outputs the log 24 indicating the error in the processing of Step 1401. In this case, the request processing part 212 adds a new record to the log table 240, registers the output time of the log 24 in the occurrence time 901 of the added record, registers the ID “006” of the screen script 500 included in the received request in the ID 902, registers the event name “Error 1” indicating an error in the event 903, and registers nothing in the accompanying information 904.

In the processing of Step 1402, the output of the log 24 of an event indicating Error 1 is registered as the specific state of the server 90 in the trigger extraction policy table 48, and hence the trigger extraction part 44 detects that the server 90 has come to the specific state. Then, in the processing of Step 1207, the trigger extraction part 44 refers to the trigger extraction policy table 48 obtained at a time of outputting the log 24 of Error 1, to execute the trigger extraction processing. Specifically, the trigger extraction part 44 executes the trigger extraction processing by using the search range 1103 and the extraction method 1104 of the record in which “Error 1” is registered in the screen URL/event 1102 of the trigger extraction policy table 48. In the trigger extraction processing, the operation for pressing the “confirm” button on the client display screen displayed by the screen script 500 whose access destination has the URL “/aaa/bbb/xxx.html” is determined as the trigger operation. The trigger extraction part 44 adds a new record to the trigger operation identifying information table 5160, registers “/aaa/bbb/xxx.html” in the screen URL 1001 of the added record, registers “pressing button” in the operation event 1002 of the added record, and registers “button, ‘confirm’” in the accompanying information 1003.

By the above-mentioned processing, the server 90 detects that the server 90 has come to the specific state when the request processing part 212 outputs the specific log 24, and executes the trigger extraction processing.

Next, outlines of the trigger extraction schemes “a” and “b” used for the trigger extraction processing are described with reference to FIG. 19 and FIG. 20.

FIG. 19 is an explanatory diagram of the outline of the trigger extraction scheme “a” according to the embodiment of this invention.

In the trigger extraction scheme “a”, the trigger extraction part 44 sums up an operation count of the same user's operation performed based on the same client screen information between a first client screen transition string including a predetermined number of pieces of client screen information that are to reach the specific screen and a second client screen transition string including the same client screen information that is to reach the specific screen as the first client screen transition string among other client screen transition strings, and determines the user operation whose operation count summed up is equal to or larger than the threshold value as the trigger operation. With this configuration, the user operation that is highly likely to reach the specific screen is determined as the trigger operation, and hence the server 90 can acquire the client screen information on which the user operation that is highly likely to reach the specific screen has been reflected.

First, the trigger extraction part 44 refers to the screen URL 703 of the screen script table 520, and detects that the specific screen has occurred (Step 1).

Subsequently, the trigger extraction part 44 acquires the client screen information within a designated range from the specific screen detected in Step 1 (Step 2). Specifically, the trigger extraction part 44 selects the record in which the screen URL of the detected specific screen is registered in the screen URL/event 1102 among the records of the trigger extraction policy table 48, and acquires a number registered in the search range 1103 of the selected record. Then, the trigger extraction part 44 refers to the screen script table 520 to acquire the screen scripts 500 existing within the acquired number from the screen script 500 for the detected specific screen. The client screen information on the specific screen detected in Step 1 and the client screen information based on the screen scripts 500 acquired in Step 2 are referred to as the first client screen transition string.

Subsequently, the trigger extraction part 44 searches the client screen information other than the client screen information acquired in Step 2 for the second client screen transition string including the same client screen information as in the first client screen transition string acquired in Step 2 (Step 3).

Subsequently, the trigger extraction part 44 refers to the operation history 14 of the same client screen information between the first client screen transition string and the second client screen transition string, to sum up the operation count of the same operation between the two pieces of client screen information (Step 4).

Subsequently, based on a summation result thereof, the trigger extraction part 44 determines the operation in which the operation count of the same operation is equal to or larger than the threshold value as the trigger operation (Step 5).

The trigger operation determined in the trigger extraction scheme “a” is the user operation having a large operation count based on the client screen information that is to reach the specific screen, and is therefore estimated as the user operation that is highly likely to reach the specific screen.

It should be noted that the processing of the trigger extraction scheme “a” is described in detail with reference to FIG. 24.

FIG. 20 is an explanatory diagram of the outline of the trigger extraction scheme “b” according to the embodiment of this invention.

In the trigger extraction scheme “b”, the trigger extraction part 44 sums up an operation count of the same user's operation performed based on the same client screen information between the first client screen transition string including the predetermined number of pieces of client screen information that are to reach the specific screen and a third client screen transition string including the same client screen information as the client screen information other than the specific screen of the first client screen transition string, and determines the user operation whose operation count summed up is equal to or smaller than the threshold value as the trigger operation. With this configuration, the user operation that is highly likely to reach the specific screen is determined as the trigger operation, and hence the server 90 can acquire the client screen information on which the user operation that is highly likely to reach the specific screen has been reflected.

First, the trigger extraction part 44 refers to the screen URL 703 of the screen script table 520, and detects that the specific screen has occurred (Step 1).

Subsequently, the trigger extraction part 44 acquires the client screen information within the designated range from the specific screen detected in Step 1 (Step 2). Step 1 and Step 2 of the trigger extraction scheme “b” are the same processing as Step 1 and Step 2 of the trigger extraction scheme “a”, and hence specific descriptions thereof are omitted.

Subsequently, the trigger extraction part 44 searches the client screen information other than the client screen information acquired in Step 2 in the screen script table 520 for the third client screen transition string including the same client screen information as the client screen information other than the specific screen of the first client screen transition string acquired in Step 2.

Subsequently, the trigger extraction part 44 refers to the operation history 14 of the same client screen information between the first client screen transition string and the third client screen transition string, to sum up the operation count of the same operation between the two pieces of client screen information (Step 4).

Subsequently, based on a summation result thereof, the trigger extraction part 44 determines the operation in which the operation count of the same operation is equal to or smaller than the threshold value as the trigger operation (Step 5).

The trigger operation determined in the trigger extraction scheme “b” is the user operation having a small operation count between given client screen information that is to reach the specific screen and the same client screen information that is not to reach the specific screen as the given client screen information. In other words, when it is considered that the specific screen is reached because the user operation having a small operation count has been performed, the user operation is estimated as the user operation that is highly likely to reach the specific screen.

It should be noted that the trigger extraction scheme “b” is described in detail with reference to FIG. 25.

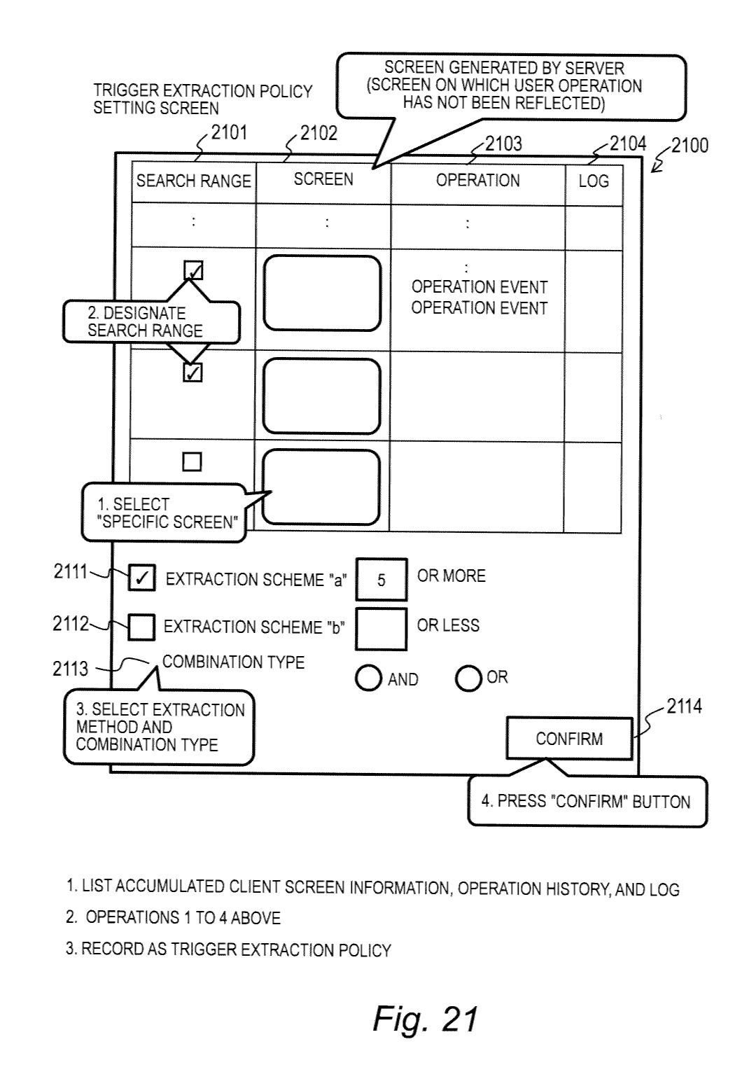

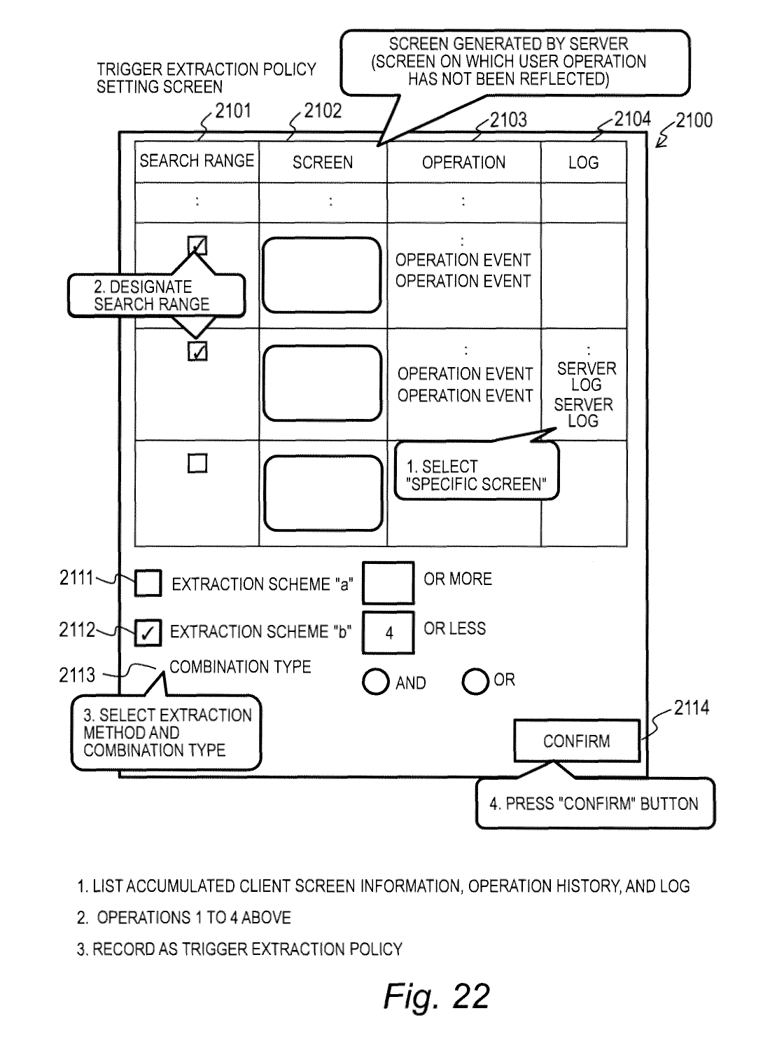

Next, a trigger extraction policy setting screen 2100 for setting the trigger extraction policy table 48 is described with reference to FIG. 21 and FIG. 22. The trigger extraction policy setting screen 2100 is displayed on a display apparatus (not shown) by the server 90.

FIG. 21 is an explanatory diagram of the trigger extraction policy setting screen 2100 according to the embodiment of this invention.

The trigger extraction policy setting screen 2100 includes a search range 2101, a screen 2102, an operation 2103, a log 2104, an extraction scheme “a” setting field 2111, an extraction scheme “b” setting field 2112, and a combination type setting field 2113.

The search range 2101 is a field for setting a range of the client screen information 13 to be acquired to determine the trigger operation. In the screen 2102, the client screen displayed on the client PC 10 by the screen script 500 stored in the screen script table 520 is displayed.

In the operation 2103, the user operation received on the client screen displayed on the screen 2102 is displayed. Specifically, the server 90 displays an operation indicated by the record in which the ID of the screen script 500 corresponding to the client screen displayed on the screen 2102 is registered in the ID 802 among the records registered in the operation history table 140, as the user operation received on the client screen.

In the log 2104, the log 24 indicating the operating behavior of the request processing part 212 that is executing the processing corresponding to the request including the ID of the screen script 500 for displaying the client screen displayed on the screen 2102 is displayed. Specifically, the server 90 displays the log 24 indicated by the record in which the ID of the screen script 500 corresponding to the client screen displayed on the screen 2102 is registered in the ID 902 among the records registered in the log table 240.

It should be noted that, from the information displayed in the screen 2102, the operation 2103, and the log 2104 of the trigger extraction policy setting screen 2100, the user selects the specific states of the server 90 and the client PC 10 serving as the timing to start the execution of the trigger extraction processing.

When a given client screen displayed in the screen 2102 is selected, the server 90 refers to the screen script table 520 to acquire the URLs registered in the screen URL 703 of the record in which the ID of the screen script 500 corresponding to the selected client screen is registered in the ID 702. Then, the server 90 adds a new record to the trigger extraction policy table 48, registers screen generation in the type 1101 of the added record, and registers the acquired URL in the screen URL/event 1102 of the added record.

Further, when a given user operation displayed in the operation 2103 is selected, the server 90 adds a new record to the trigger extraction policy table 48, registers client notification in the type 1101 of the added record, and registers the selected user operation in the screen URL/event 1102 of the added record.

Further, when a given log 24 displayed in the log 2104 is selected, the server 90 adds a new record to the trigger extraction policy table 48, registers the log in the type 1101 of the added record, and registers the event indicated by the selected log 24 in the screen URL/event 1102 of the added record.

The extraction scheme “a” setting field 2111 includes a checkbox for selecting whether or not to execute the trigger extraction processing by using the trigger extraction scheme “a” and a field for setting the threshold value used to extract the trigger operation in the trigger extraction scheme “a”.

The extraction scheme “b” setting field 2112 includes a checkbox for selecting whether or not to execute the trigger extraction processing by using the trigger extraction scheme “b” and a field for setting the threshold value used to extract the trigger operation in the trigger extraction scheme “b”.

The combination type setting field 2113 is a field for allowing the user to select how to combine the trigger operation extracted by the trigger extraction scheme “a” and the trigger operation extracted by the trigger extraction scheme “b” when the checkbox of the extraction scheme “a” setting field 2111 is checked and the checkbox of the extraction scheme “b” setting field 2112 is checked. When “and” is selected in the combination type setting field 2113, the same trigger operation between the trigger operation extracted by the trigger extraction scheme “a” and the trigger operation extracted by the trigger extraction scheme “b” is determined as the trigger operation. Further, when “or” is selected in the combination type setting field 2113, the trigger operation extracted by the trigger extraction scheme “a” and the trigger operation extracted by the trigger extraction scheme “b” are determined as the trigger operations.

It should be noted that the user's selections of the extraction scheme “a” setting field 2111, the extraction scheme “b” setting field 2112, and the combination type setting field 2113 are registered in the extraction method 1104 of the trigger extraction policy table 48.

In FIG. 21, the third client screen displayed on the screen 2102 is selected as the specific screen. Then, up to two client screens before the client screen selected by the user are selected as the search range 2101.

Further, the checkbox of the extraction scheme “a” setting field 2111 is checked, and “5” is selected as the threshold value used for the trigger extraction processing based on the trigger extraction scheme “a”.

When a “confirm” button 2114 is pressed, the contents selected on the trigger extraction policy setting screen 2100 are registered in the trigger extraction policy table 48.

FIG. 22 is an explanatory diagram of the trigger extraction policy setting screen 2100 according to the embodiment of this invention.

In FIG. 22, the log displayed on the log 2104 is selected as the specific state. Then, up to two client screens before the client screen corresponding to the log selected by the user are selected as the search range 2101.

Further, the checkbox of the extraction scheme “b” setting field 2112 is checked, and “4” is selected as the threshold value used for the trigger extraction processing based on the trigger extraction scheme “b”.

When the “confirm” button 2114 is pressed, the contents selected on the trigger extraction policy setting screen 2100 are registered in the trigger extraction policy table 48.

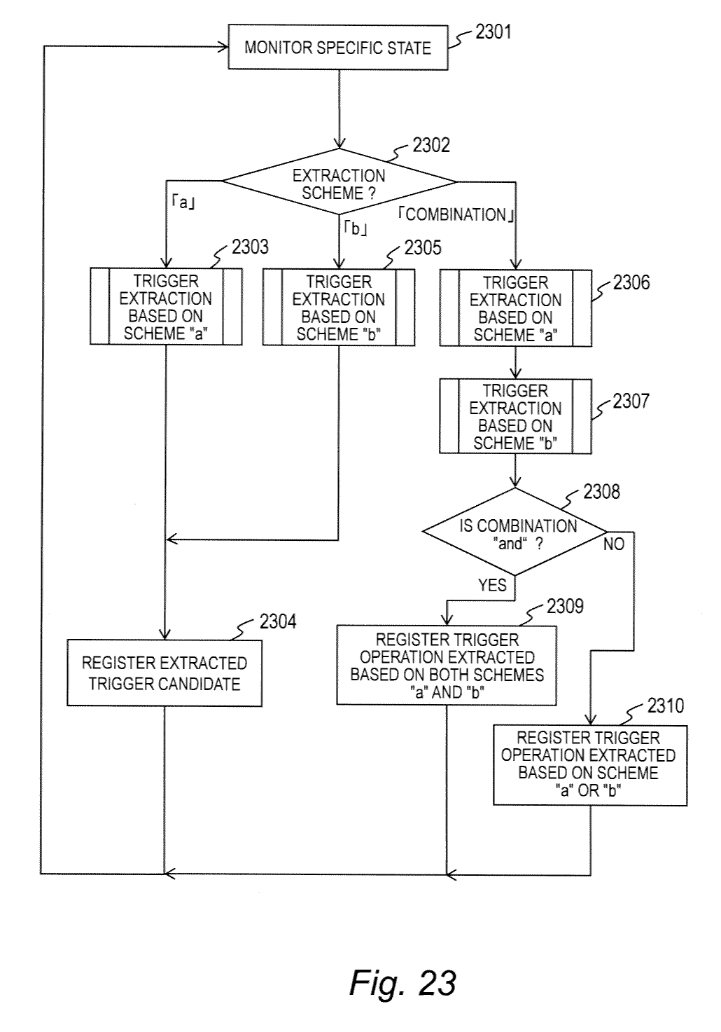

Next, the trigger extraction processing is described in detail with reference to FIG. 23 to FIG. 25.

FIG. 23 is a flowchart of the entire trigger extraction processing according to the embodiment of this invention.

First, the trigger extraction part 44 monitors whether or not at least one of the server 90 and the client PC 10 has come to the specific state (2301).

When detecting in the processing of Step 2301 that at least one of the server 90 and the client PC 10 has come to the specific state, the trigger extraction part 44 determines which of the execution of the trigger extraction processing based on the trigger extraction scheme “a”, the execution of the trigger extraction processing based on the trigger extraction scheme “b”, and the execution of the trigger extraction processing based on a combination of the trigger extraction scheme “a” and the trigger extraction scheme “b” is registered in the extraction method 1104 of the record corresponding to the detected specific state within the trigger extraction policy table 48 (2302).

When it is determined in the processing of Step 2302 that the execution of the trigger extraction processing based on the trigger extraction scheme “a” is registered in the extraction method 1104, the trigger extraction part 44 executes the trigger extraction processing based on the trigger extraction scheme “a” (2303). It should be noted that the trigger extraction processing based on the trigger extraction scheme “a” is described in detail with reference to FIG. 24. Then, the trigger extraction part 44 registers the trigger operation extracted in the processing of Step 2303 in the trigger operation identifying information table 5160 (2304), and the procedure returns to the processing of Step 2301.

When it is determined in the processing of Step 2302 that the execution of the trigger extraction processing based on the trigger extraction scheme “b” is registered in the extraction method 1104, the trigger extraction part 44 executes the trigger extraction processing based on the trigger extraction scheme “b” (2305). It should be noted that the trigger extraction processing based on the trigger extraction scheme “b” is described in detail with reference to FIG. 25. Then, in the processing of Step 2304, the trigger extraction part 44 registers the trigger operation extracted in the processing of Step 2305 in the trigger operation identifying information table 5160, and the procedure returns to the processing of Step 2301.

When it is determined in the processing of Step 2302 that the execution of the trigger extraction processing based on the combination of the trigger extraction scheme “a” and the trigger extraction scheme “b” is registered, the trigger extraction part 44 executes the trigger extraction processing based on the trigger extraction scheme “a” (2306), and executes the trigger extraction processing based on the trigger extraction scheme “b” (2307). Subsequently, the trigger extraction part 44 determines whether or not the combination method is “and” (2308). When it is determined in the processing of Step 2308 that the combination method is “and”, the trigger extraction part 44 registers the same trigger operation between the trigger operation extracted by the trigger extraction scheme “a” and the trigger operation extracted by the trigger extraction scheme “b” in the trigger operation identifying information table 5160 (2309), and the procedure returns to the processing of Step 2301. When it is determined in the processing of Step 2308 that the combination method is not “and”, in other words, the combination method is “or”, the trigger extraction part 44 registers the trigger operation extracted by the trigger extraction scheme “a” and the trigger operation extracted by the trigger extraction scheme “b” in the trigger operation identifying information table 5160 (2310), and the procedure returns to the processing of Step 2301.

FIG. 24 is a flowchart of the trigger extraction processing based on the trigger extraction scheme “a” according to the embodiment of this invention.

First, the trigger extraction part 44 acquires as many pieces of client screen information as the number registered in the search range 1103 of the record corresponding to the specific state detected in the processing of Step 2301 within the trigger extraction policy table 48, and acquires the first client screen transition string (2401).

The processing of Step 2401 is described specifically by taking a case where the specific state detected in the processing of Step 2301 is a state in which the server 90 has generated the specific screen script 500.

The trigger extraction part 44 acquires the record in which the ID of the specific screen script 500 is registered in the ID 702 of the screen script table 520. Then, the trigger extraction part 44 acquires the record existing between within the number registered in the search range 1103 of the trigger extraction policy table 48 from the acquired record. Then, the trigger extraction part 44 acquires the transition of the client screen information to be displayed on the client PC 10 by the screen script 500 identified by the acquired record, as the first client screen transition string.

Next, the processing of Step 2401 is described specifically by taking a case where the specific state detected in the processing of Step 2301 is a state in which the client PC 10 has received the specific user operation. It should be noted that a script for transmitting, when the client PC 10 receives a specific user operation, a notification to that effect to the server 90 is assumed to be inserted into the screen script 500 that allows the specific user operation. The notification that the specific user operation has been received includes the ID of the screen script 500 being executed by the client PC 10 when receiving the user operation.

The trigger extraction part 44 acquires the record in which the ID of the screen script 500 included in the notification that the specific user operation has been received is registered in the ID 702 of the screen script table 520. The subsequent processing is the same as in the case where the state in which the server 90 has generated a specific screen script is detected as the specific state in the processing of Step 2301, and hence a description thereof is omitted.

Next, the processing of Step 2401 is described specifically by taking a case where the specific state detected in the processing of Step 2301 is the state in which the server 90 has output the specific log 24.

The trigger extraction part 44 acquires the record in which the ID of the screen script 500 included in the log 24 output by the request processing part 212 of the server 90 is registered in the ID 702 of the screen script table 520. The subsequent processing is the same as in the case where the state in which the server 90 has generated the specific screen script is detected as the specific state in the processing of Step 2301, and hence a description thereof is omitted.

Subsequently, the trigger extraction part 44 acquires the same transition of the client screen information as the first client screen transition string acquired in the processing of Step 2401, as the second client screen transition string (2402).

Specifically, the trigger extraction part 44 acquires a record group in which an arrangement of the URLs registered in the screen URL 703 of the screen script table 520 is the same as an arrangement of the URLs of the screen scripts 500 that form the first client screen transition string acquired in the processing of Step 2401. Then, the trigger extraction part 44 acquires the transition of the client screen information to be displayed on the client PC 10 by the screen scripts 500 identified by the acquired record group, as the second client screen transition string.

Subsequently, the trigger extraction part 44 sums up the operation count of the same user operation performed on the same client screen between the first client screen transition string acquired in the processing of Step 2401 and the second client screen transition string acquired in the processing of Step 2402 (2403).

Specifically, the trigger extraction part 44 identifies the screen scripts 500 having the URLs matching each other between the screen scripts 500 that form the first client screen transition string and the screen scripts 500 that form the second client screen transition string. Then, the trigger extraction part 44 acquires the operation event 804 and the accompanying information 805 of the record in which the ID 802 of the operation history table 140 matches the ID of each of the screen scripts 500. When the pieces of information registered in the operation event 804 and the accompanying information 805 acquired by the respective screen scripts 500 match each other, the trigger extraction part 44 increments the operation count of the operation identified by the information registered in the operation event 804 and the accompanying information 805.

Subsequently, the trigger extraction part 44 determines the operation whose operation count summed up in the processing of Step 2403 is equal to or larger than the threshold value as the trigger operation (2404), and the processing is brought to an end.

FIG. 25 is a flowchart of the trigger extraction processing based on the trigger extraction scheme “b” according to the embodiment of this invention. The same processing illustrated in FIG. 25 as the processing illustrated in FIG. 24 is denoted by the same reference numeral, and a description thereof is omitted.

The trigger extraction part 44 acquires the transition including the same client screen information as the client screen information other than the client screen information based on the screen script 500 corresponding to the specific state within the first client screen transition string acquired in the processing of Step 2401, as the third client screen transition string (2501).

Specifically, the trigger extraction part 44 acquires the record group in which the arrangement of the URLs registered in the screen URL 703 of the screen script table 520 is the same as the arrangement of the URLs of the screen scripts 500 other than the screen script 500 corresponding to the specific state among the screen scripts 500 that form the first client screen transition string acquired in the processing of Step 2401. Then, the trigger extraction part 44 acquires the transition of the client screen information to be displayed on the client PC 10 by the screen scripts 500 identified by the acquired record group, as the third client screen transition string.

The trigger extraction part 44 determines the operation whose operation count summed up in the processing of Step 2403 is equal to or smaller than the threshold value as the trigger operation (2502), and the processing is brought to an end.

It should be noted that the trigger extraction part 44 may acquire the first client screen transition string, the second client screen transition string, and the third client screen transition string with a limitation to the client screen information having the same operating environment of the client PC 10 and the same user ID of the user of the client PC 10. Examples of the operating environment of the client PC 10 include a kind of browser 11, a kind of OS running on the client PC 10, and a kind of device of the client PC 10.

Specifically, before transmitting the request to the server 90, the client PC 10 includes the operating environment and the user ID of its own in the request to be transmitted. Then, the server 90 generates the screen script 500 corresponding to the received request, and when recording the generated screen script 500 in the screen script table 520, records the operating environment of the client PC 10 and the user ID included in the request corresponding to the generated screen script 500 in the screen script table 520 in association with the ID included in the generated screen script 500.

When detecting that at least one of the server 90 and the client PC 10 has come to the specific state, the trigger extraction part 44 refers to the screen script table 520 to acquire the operating environment and the user ID associated with the ID of the screen script 500 corresponding to the specific state. Then, the trigger extraction part 44 refers to the screen script table 520 to acquire the screen scripts 500 for displaying the client screen information 13 that form the first client screen transition string, the second client screen transition string, and the third client screen transition string from among the screen scripts 500 whose operating environment and user ID match at least one of the acquired operating environment and the acquired user ID.

The operating environment of the client PC 10, an operation method unique to the user, or the like is conceivable as the cause of bringing the server 90 and the client PC 10 to the specific states. The trigger extraction part 44 determines the trigger operation with a limitation to the client screen information 13 having at least one of the same operating environment of the client PC 10 and the same user ID, and hence the operation that is more highly likely to reach the specific state can be determined as the trigger operation.

Further, the trigger extraction part 44 determines the trigger operation in units of user operations based on the trigger extraction scheme “a” and the trigger extraction scheme “b”, but may determine the trigger operation in units of operation strings each of which is formed of a plurality of user operations.

Further, the case where the trigger extraction part 44 executes the trigger extraction processing when at least one of the server 90 and the client PC 10 comes to the specific state has been described, but a timing to execute the trigger extraction processing is not limited to the case where at least one of the server 90 and the client PC 10 has come to the specific state, and may be, for example, a timing at which a new trigger extraction policy is registered in the trigger extraction policy table 48 through the trigger extraction policy setting screen 2100.

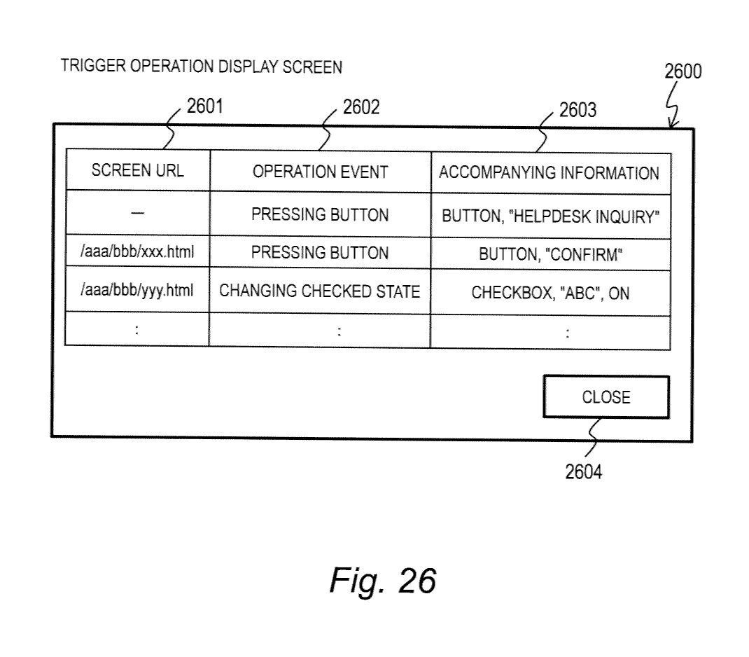

The server 90 can display the trigger operation registered in the trigger operation identifying information table 5160 as a trigger operation display screen 2600 as illustrated in FIG. 26 in response to the request of the administrator. The trigger operation display screen 2600 is described with reference to FIG. 26.

FIG. 26 is an explanatory diagram of the trigger operation display screen 2600 according to the embodiment of this invention.

The trigger operation display screen 2600 includes a screen URL 2601, an operation event 2602, accompanying information 2603, and a close button 2604.

In the screen URL 2601, the URL registered in the screen URL 1001 of the trigger operation identifying information table 5160 is displayed. In the operation event 2602, an operation event registered in the operation event 1002 of the trigger operation identifying information table 5160 is displayed. In the accompanying information 2603, the information registered in the accompanying information 2603 of the trigger operation identifying information table 5160 is displayed. When the close button 2604 is pressed, the server 90 closes a window of the trigger operation display screen 2600.

With this configuration, the administrator can confirm the trigger operation set on the server 90.

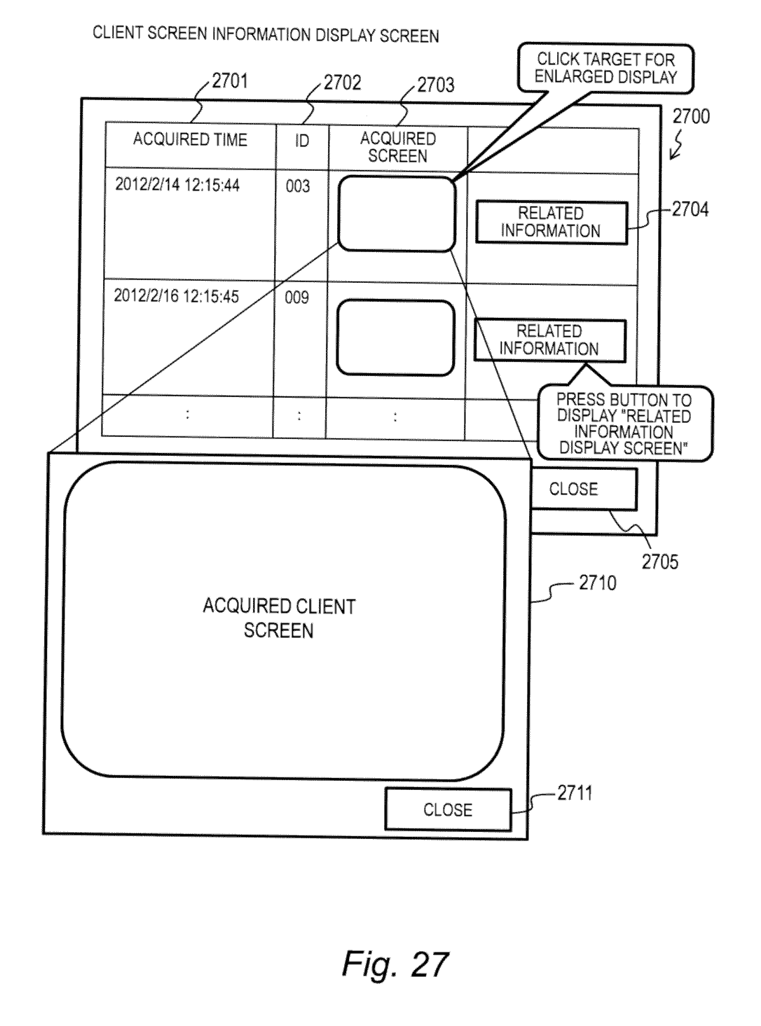

Further, the server 90 can display the client screen information 13 acquired from the client PC 10 in response to the request of the administrator and recorded in the client screen information table 130, as a client screen information display screen 2700 as illustrated in FIG. 27. The client screen information display screen 2700 is described with reference to FIG. 27.

FIG. 27 is an explanatory diagram of the client screen information display screen 2700 according to the embodiment of this invention.

The client screen information display screen 2700 includes an acquired time 2701, an ID 2702, an acquired screen 2703, a related information button 2704, and a close button 2705.

In the acquired time 2701, a time at which the client screen information 13 is acquired is displayed. In the ID 2702, the ID of the screen script 500 that has displayed the acquired client screen information 13 is displayed. In the acquired screen 2703, the acquired client screen information 13 is displayed. When the related information button 2704 is pressed, the server 90 displays information (for example, operation history 14 and log 24) related to the client screen information corresponding to the pressed related information button 2704. When the close button 2705 is pressed, the server 90 closes a window of the client screen information display screen 2700.

Further, when the client screen information 13 displayed on the acquired screen 2703 is pressed, the server 90 displays an enlarged display screen 2710 obtained by enlarging the pressed client screen information 13. The enlarged display screen 2710 includes a close button 2711, and when the close button is pressed, a window of the enlarged display screen 2710 is closed.

With this configuration, the administrator can confirm the client screen information 13 acquired by the server 90.

What is claimed is:

1. A screen information collecting computer for collecting client screen information serving as information on a client screen from a client computer for receiving a user's operation performed on the client screen being displayed, the screen information collecting computer comprising:
a client screen information collection part for collecting the client screen information from the client computer;
an operation information collection part for collecting operation information indicating information by which the user's operation performed on the client screen is identifiable; and
a trigger operation determination part for determining, among the user's operations on the client screen, a trigger operation indicating a timing to control the client screen information collection part to collect the client screen information,
the trigger operation determination part being configured to determine the trigger operation based on the client screen information displayed on the client computer and the operation information.

2. The screen information collecting computer according to claim 1, wherein the client screen information collection part is configured to:
transmit trigger operation identifying information, by which the trigger operation determined by the trigger operation determination part is identifiable, to the client computer; and
collect the client screen information by receiving the client screen information transmitted in a case where the client computer receives the trigger operation identified by the trigger operation identifying information.

3. The screen information collecting computer according to claim 2, wherein the client screen information collection part transmits a screen script for generating the client screen by being executed by the client computer to the client computer by embedding the trigger operation identifying information into the screen script.

4. The screen information collecting computer according to claim 1, further comprising:
a request processing part for executing processing corresponding to a request transmitted by the client computer when the client computer receives a request operation on the client screen, and outputting a log indicating an operating behavior of the request processing part itself;
a screen script generation part for generating a screen script for generating the client screen by being executed by the client computer based on a processing result from the request processing part; and
an identification information generation part for generating identification information on the screen script generated by the screen script generation part, and assigning the generated identification information to the screen script, wherein:
the client screen information collection part collects the client screen information comprising the identification information assigned to the screen script for displaying the client screen;
the operation information collection part collects the operation information including the identification information assigned to the screen script for displaying the client screen on which an operation identified by the operation information has been performed;
the request processing part outputs the log including the identification information assigned to the screen script for displaying the client screen on which the request operation has been performed; and
the client screen information, the operation information, and the log are associated with one another by the identification information assigned to the screen script.

5. The screen information collecting computer according to claim 1, wherein the trigger operation determination part determines the trigger operation based on: the client screen information including at least one of the same operating environment of the client computer or the same user identification information on the client computer; and the operation information.

6. The screen information collecting computer according to claim 1, wherein the trigger operation determination part determines the trigger operation in a case of detecting that at least one of the client computer or the screen information collecting computer has come to a specific state.

7. The screen information collecting computer according to claim 6, wherein the trigger operation determination part is configured to:
acquire, in a case of detecting that the at least one of the client computer or the screen information collecting computer has come to the specific state, a predetermined number of pieces of client screen information that are to reach the client screen information corresponding to the specific state as a first client screen transition string;
determine, based on the acquired first client screen transition string, the trigger operation by using at least one of a first scheme or a second scheme;
in the first scheme:
acquire, from the client screen information displayed on the client computer, the client screen information including the same transition as the acquired first client screen transition string as a second client screen transition string;
sum up an operation count of the same operation from the operation information obtained based on the same client screen information between the first client screen transition string and the second client screen transition string; and
determine an operation whose operation count summed up is equal to or larger than a first predetermined value as the trigger operation; and
in the second scheme:
acquire, from the client screen information displayed on the client computer, the client screen information including the same client screen information as the client screen information other than the client screen information corresponding to the specific state within the acquired first client screen transition string, as a third client screen transition string;
sum up the operation count of the same operation from the operation information obtained based on the same client screen information between the first client screen transition string and the third client screen transition string; and
determine an operation whose operation count summed up is equal to or smaller than a second predetermined value as the trigger operation.

8. The screen information collecting computer according to claim 1, further comprising at least one of:
a trigger operation display part for displaying the trigger operation determined by the trigger operation determination part; or
a client screen information display part for displaying the client screen information collected by the client screen information collection part.

9. The screen information collecting computer according to claim 1, wherein the trigger operation includes a plurality of operations performed by the user on the client screen.

10. A screen information collecting method to be performed in a system,
the system having:
a client computer for receiving a user's operation on a client screen being displayed; and
a screen information collecting computer for collecting client screen information serving as information on a client screen from the client computer,
the screen information collecting method including:
a first step of collecting, by the screen information collecting computer, the client screen information from the client computer;
a second step of collecting, by the screen information collecting computer, operation information indicating information by which the user's operation on the client screen is identifiable; and
a third step of determining, by the screen information collecting computer, among the user's operations on the client screen, a trigger operation indicating a timing to collect the client screen information in the first step,
the third step including determining the trigger operation based on the client screen information displayed on the client computer and the operation information.

11. The screen information collecting method according to claim 10, wherein the first step comprises:
transmitting, by the screen information collecting computer, trigger operation identifying information, by which the trigger operation determined in the third step is identifiable, to the client computer;
transmitting, by the client computer, the client screen information to the screen information collecting computer in a case of receiving the trigger operation identified by the trigger operation identifying information; and
collecting, by the screen information collecting computer, the client screen information by receiving the client screen information.

12. The screen information collecting method according to claim 11, wherein the first step comprises transmitting, by the screen information collecting computer, a screen script for generating the client screen by being executed by the client computer to the client computer by embedding the trigger operation identifying information into the screen script.

13. The screen information collecting method according to claim 10, further comprising:
a fourth step of transmitting, by the client computer, a request in a case of receiving a request operation on the client screen;
a fifth step of executing, by the screen information collecting computer, processing corresponding to the request in a case of receiving the request, and outputting a log indicating an operating behavior of the screen information collecting computer itself;
a sixth step of generating, by the screen information collecting computer, a screen script for generating the client screen by being executed by the client computer based on a processing result in the fifth step; and
a seventh step of generating, by the screen information collecting computer, identification information on the screen script generated in the sixth step, and assigning the generated identification information to the screen script, wherein:
the first step includes collecting, by the screen information collecting computer, the client screen information including the identification information assigned to the screen script for displaying the client screen;
the second step includes collecting, by the screen information collecting computer, the operation information including the identification information assigned to the screen script for displaying the client screen on which an operation identified by the operation information has been performed;
the fifth step includes outputting, by the screen information collecting computer, the log including the identification information assigned to the screen script for displaying the client screen on which the request operation has been performed; and
the client screen information, the operation information, and the log are associated with one another by the identification information assigned to the screen script.

14. The screen information collecting method according to claim 10, wherein the third step includes determining, by the screen information collecting computer, the trigger operation based on: the client screen information including at least one of the same operating environment of the client computer or the same user identification information on the client computer; and the operation information.

15. The screen information collecting method according to claim 10, wherein the third step includes determining the trigger operation in a case of detecting that at least one of the client computer or the screen information collecting computer has come to a specific state.

16. The screen information collecting method according to claim 15, wherein the third step includes:
acquiring, by the screen information collecting computer, in a case of detecting that the at least one of the client computer or the screen information collecting computer has come to the specific state, a predetermined number of pieces of client screen information that are to reach the client screen information corresponding to the specific state as a first client screen transition string;
determining, by the screen information collecting computer, based on the acquired first client screen transition string, the trigger operation by using at least one of a first scheme or a second scheme;
in the first scheme:
acquiring, by the screen information collecting computer, from the client screen information displayed on the client computer, the client screen information including the same transition as the acquired first client screen transition string as a second client screen transition string;
summing up, by the screen information collecting computer, an operation count of the same operation from the operation information obtained based on the same client screen information between the first client screen transition string and the second client screen transition string; and
determining, by the screen information collecting computer, an operation whose operation count summed up is equal to or larger than a first predetermined value as the trigger operation; and
in the second scheme:
acquiring, by the screen information collecting computer, from the client screen information displayed on the client computer, the client screen information including the same client screen information as the client screen information other than the client screen information corresponding to the specific state within the acquired first client screen transition string, as a third client screen transition string;
summing up, by the screen information collecting computer, the operation count of the same operation from the operation information obtained based on the same client screen information between the first client screen transition string and the third client screen transition string; and
determining, by the screen information collecting computer, an operation whose operation count summed up is equal to or smaller than a second predetermined value as the trigger operation.

17. The screen information collecting method according to claim 10, further including at least one of:
an eighth step of displaying, by the screen information collecting computer, the trigger operation determined in the third step; or
a ninth step of displaying, by the screen information collecting computer, the client screen information collected in the first step.

18. The screen information collecting method according to claim 10, wherein the trigger operation includes a plurality of operations performed by the user on the client screen.

19. A computer-readable storage medium having stored thereon a program to be executed by a screen information collecting computer for collecting client screen information serving as information on a client screen from a client computer for receiving a user's operation on the client screen being displayed, the screen information collecting computer comprising a processor and a storage area, the program controlling the processor to execute processing of collecting the information on the client screen,
the processing including:
processing of collecting the client screen information from the client computer;
processing of collecting operation information indicating information by which the user's operation on the client screen is identifiable; and
processing of determining, among the user's operations on the client screen, a trigger operation indicating a timing to collect the client screen information,
the processing of determining the trigger operation including determining the trigger operation based on the client screen information displayed on the client computer and the operation information.
